(19) United States
(12) Patent Application Publication
(10) Pub. No.: US 2026/0349757 A1
(43) Pub. Date: Nov. 5, 2026

(54) ELECTRONIC DEVICE, METHOD, AND NON-TRANSITORY COMPUTER READABLE STORAGE MEDIUM FOR DISPLAYING WINDOW OF APPLICATION

(71) Applicant: SAMSUNG ELECTRONICS CO., LTD., Suwon-si (KR)

(72) Inventors: Juneup Park, Suwon-si (KR); Daesik Hwang, Suwon-si (KR); Choonhee Shim, Suwon-si (KR); Jooyong Kim, Suwon-si (KR); Jeongseob Kim, Suwon-si (KR); Sangheon Kim, Suwon-si (KR); Munhwi Kim, Suwon-si (KR)

(73) Assignee: SAMSUNG ELECTRONICS CO., LTD., Suwon-si (KR)

(21) Appl. No.: 19/468,356

(22) Filed: Feb. 3, 2026

Related U.S. Application Data
(63) Continuation of application No. PCT/KR2026/001217, filed on Jan. 21, 2026.

(30) Foreign Application Priority Data
Apr. 30, 2025 (KR) 10-2025-0057847
May 29, 2025 (KR) 10-2025-0070832

(51) Int. Cl. G06F 9/451; G06F 3/04883; G06F 3/04886

(52) U.S. Cl. CPC G06F 9/451; G06F 3/04883; G06F 3/04886; G06F 2203/04803

(57) ABSTRACT

A method of an electronic device including a display, includes: identifying an input for displaying an execution history screen of applications; based on the input, displaying, via the display, the execution history screen including: a first image for an execution screen of a first application executed in a desktop mode having a first user interface (UI) displaying both window control buttons and an application execution screen, and a second image for an execution screen of a second application executed in a tablet mode having a second UI displaying the application execution screen; displaying, via the display, a window including both the execution screen of the first application and the window control buttons, in the desktop mode; and based on identifying an input related to the second image in the execution history screen, displaying, via the display, a window including the execution screen of the second application, in the tablet mode.

### CROSS-REFERENCE TO RELATED APPLICATIONS

This application is a by-pass continuation application of International Application No. PCT/KR2026/001217, filed on Jan. 21, 2026, which is based on and claims priority to Korean Patent Application No. 10-2025-0057847, filed on Apr. 30, 2025, and Korean Patent Application 10-2025-0070832, filed on May 29, 2025, in the Ministry of Intellectual Property, the disclosures of which are incorporated by reference herein their entireties.

### BACKGROUND

### 1. Field

The present disclosure relates to an electronic device, a method, and a non-transitory computer readable storage medium for displaying a window of an application.

### 2. Description of Related Art

In response to execution of an application, an electronic device may display a window of the application using all or a portion of a screen displayed via a display (for example, an external monitor).

The above-described information may be provided as related art for the purpose of helping the understanding of the present disclosure. No claim or determination is raised as to whether any of the above-described content may be applied as prior art related to the present disclosure.

### SUMMARY

According to an aspect of the disclosure, an electronic device includes: a display; memory, including one or more storage media, storing instructions; and at least one processor including processing circuitry, wherein the instructions, when executed by the at least one processor individually or collectively, cause the electronic device to: identify an input for displaying an execution history screen of applications; based on the input, display, via the display, the execution history screen including: a first image for an execution screen of a first application executed in a desktop mode having a first user interface (UI) configuration displaying both window control buttons and an application execution screen, and a second image for an execution screen of a second application executed in a tablet mode having a second UI configuration displaying the application execution screen; based on identifying an input related to the first image in the execution history screen, display, via the display, a first window including both the execution screen of the first application and the window control buttons, in the desktop mode; and based on identifying an input related to the second image in the execution history screen, display, via the display, a second window including the execution screen of the second application, in the tablet mode.

According to an aspect of the disclosure, a method performed by an electronic device including a display, includes: identifying an input for displaying an execution history screen of applications; based on the input, displaying, via the display, the execution history screen including: a first image for an execution screen of a first application executed in a desktop mode having a first user interface (UI) configuration displaying both window control buttons and an application execution screen, and a second image for an execution screen of a second application executed in a tablet mode having a second UI configuration displaying the application execution screen; based on identifying an input related to the first image in the execution history screen, displaying, via the display, a first window including both the execution screen of the first application and the window control buttons, in the desktop mode; and based on identifying an input related to the second image in the execution history screen, displaying, via the display, a second window including the execution screen of the second application, in the tablet mode.

According to an aspect of the disclosure, a non-transitory computer readable storage medium store one or more programs, wherein the one or more programs, when executed by at least one processor of an electronic device individually or collectively, include instructions that cause the electronic device to identify an input for displaying an execution history screen of applications, to display, via the display, based on the input, the execution history screen comprising a first image for an execution screen of a first application executed in a desktop mode having a first UI configuration displaying both window control buttons and an application execution screen, and a second image for an execution screen of a second application executed in a tablet mode having a second UI configuration displaying the application execution screen, to display, via the display, a window including both the execution screen of the first application and the window control buttons using the desktop mode, based on identifying an input related to the first image in the execution history screen, and to display, via the display, a window including the execution screen of the second application using the tablet mode, based on identifying an input related to the second image in the execution history screen.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment;

FIG. 2A illustrates components of an electronic device;

FIG. 2B illustrates a block diagram for describing operations of an electronic device for determining an execution mode of an application;

FIGS. 3A to 3C illustrate an example of activating a tablet mode or a desktop mode via a settings screen;

FIG. 4 illustrates a flowchart indicating operations of an electronic device for displaying windows in a desktop mode;

FIGS. 5A and 5B illustrate an example of displaying windows in a desktop mode;

FIG. 6 illustrates an example of displaying windows in a desktop mode;

FIGS. 7A and 7B illustrate an example of displaying a window in a desktop mode;

FIG. 8 illustrates a flowchart indicating operations of an electronic device for displaying windows in a tablet mode;

FIG. 9 illustrates an example of displaying a window in a tablet mode;

FIG. 10A illustrates an example of displaying split screen in a tablet mode;

FIG. 10B illustrates an example of displaying split screen in a tablet mode;

FIG. 11 illustrates signaling between a home application and a window manager for displaying a window;

FIG. 12 is a flowchart indicating operations of an electronic device for displaying a window in a desktop mode or a tablet mode; and

FIG. 13 illustrates a flowchart indicating operations of a foldable electronic device for displaying an execution history screen.

### DETAILED DESCRIPTION

Terms used in the present disclosure are used only to describe a specific embodiment, and may not be intended to limit a range of another embodiment. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}.

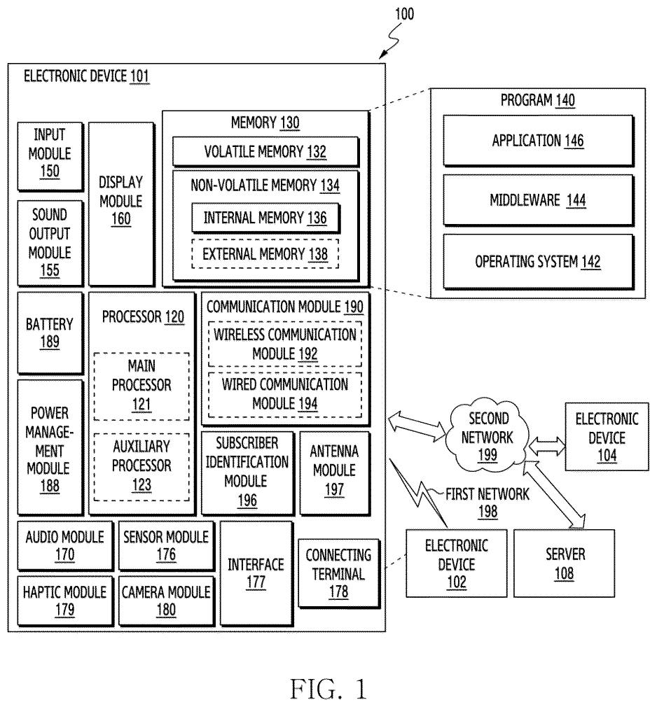

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., through at least one wire) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through at least one wire) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 performs a function or a service automatically, or in response to or based on a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

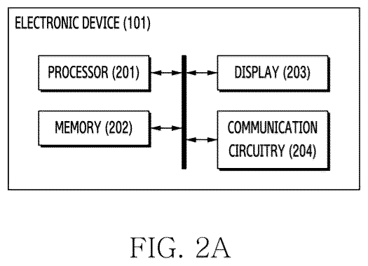

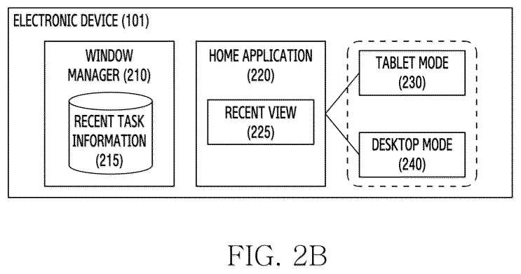

FIG. 2A illustrates components of an electronic device.

Referring to FIG. 2A, an electronic device 101 may include a processor 201, memory 202, a display 203, and communication circuitry 204. For example, the processor 201, the memory 202, the display 203, and the communication circuitry 204 may be electronically and/or operably coupled with each other by a communication bus. Hardware components being operably coupled with each other may mean that a direct connection or an indirect connection is established between the hardware components by a wire or wirelessly, such that a second hardware component (e.g., the memory 202, the display 203, and the communication circuitry 204) is controlled by a first hardware component (e.g., the processor 201) among the hardware components. Although the hardware components illustrated in FIG. 2A are illustrated based on different blocks, the present disclosure is not limited to the different blocks. For example, at least a portion (e.g., the processor 201, the memory 202, the display 203, and/or the communication circuitry 204) of the hardware components illustrated in FIG. 2A may be included in a single integrated circuit such as a system on chip (SoC) or a system in package (SiP). In addition, a type and the number of hardware components included in the electronic device 101 is not limited to that illustrated in FIG. 2A. For example, the electronic device 101 may include only a portion of the hardware components illustrated in FIG. 2A.

In an embodiment, the electronic device 101 may include the processor 201. The processor 201 may include a hardware component for processing data based on one or more instructions. The hardware component for processing data may include, for example, an arithmetic and logic unit (ALU), a floating point unit (FPU), and/or a field programmable gate array (FPGA). As an example, the hardware component for processing data may include a central processing unit (CPU), a graphics processing unit (GPU), digital signal processor (DSP), a microcontroller (MCU) and/or a neural processing unit (NPU). The number of processors 201 may be one or more. For example, the processor 201 may have a structure of a multi-core processor such as a dual core, a quad core, or a hexa core. The description of the processor 120 of FIG. 1 may be applied in substantially the same manner to the processor 201 of FIG. 2.

In an embodiment, the processor 201 may include various processing circuitry and/or a plurality of processors. For example, the term “processor” used in the present document, including the claims, may include various processing circuitry including at least one processor, and one or more of the at least one processor may be configured to perform, individually and/or collectively, various functions described below in a distributed manner. As used herein, when the terms “processor,” “at least one processor,” and “one or more processors” are described as being configured to perform various functions, such terms may encompass, for example, without limitation, situations in which one processor performs a portion of the cited functions and other processor(s) perform another portion of the cited functions, as well as situations in which one processor may perform all of the cited functions. Additionally, the at least one processor may include a combination of processors that perform the various enumerated/disclosed functions, for example, in a distributed manner. The at least one processor may execute program instructions to achieve or perform various functions.

In an embodiment, the electronic device 101 may include the memory 202. The memory 202 may include a hardware component for storing data and/or instructions input to the processor 201 and/or output from the processor 201. For example, the memory 202 may include a volatile memory such as a random-access memory (RAM) and/or a non-volatile memory such as a read-only memory (ROM). The volatile memory may include, for example, at least one of a dynamic RAM (DRAM), a static RAM (SRAM), a Cache RAM, or a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, or an embedded multimedia card (eMMC).

In an embodiment, one or more instructions (or commands) indicating a computation and/or an operation performed by the processor 201 of the electronic device 101 may be stored in the memory 202 of the electronic device 101. A set of one or more instructions may be referred to as a program, firmware, an operating system, a process, a routine, a sub-routine, and/or an application. Hereinafter, an application being installed in the electronic device 101 may mean that one or more instructions provided in a form of the application are stored in the memory 202, and that one or more applications are stored in a format executable by the processor 201 of the electronic device 101. Specific description of the memory 202 of FIG. 2A may be applied in substantially the same manner as the description of the memory 130 of FIG. 1.

In an embodiment, the electronic device 101 may include the display 203. The display 203 may include a display panel, a touch sensor, and/or processing circuitry. In an embodiment, the display panel may be used to display visual information (e.g., an image, a button affordance, a screen, an object, a visual object, a user interface (UI), a UI element, and/or a graphic user interface (GUI)). For example, the display panel may have a display area for displaying visual information and for receiving a touch input. In an embodiment, the touch sensor may be positioned within or on the display panel to provide the display area of the display panel for receiving a touch input. For example, the touch sensor may be configured to obtain data for contact points on at least a portion of the display area. In an embodiment, the processing circuitry may be configured to control the touch sensor. For example, the processing circuitry may be configured to process signals or data obtained (or received) via the touch sensor. Specific description of the display 203 of FIG. 2A may be applied in substantially the same manner as the description of the display module 160 of FIG. 1.

In an embodiment, the electronic device 101 may include the communication circuitry 204. The communication circuitry 204 may include circuitry for supporting transmission and/or reception of an electrical signal between the electronic device 101 and an external device. For example, the communication circuitry 204 may include at least one of a modem, an antenna, or an optic/electronic converter (O/E). For example, the communication circuitry 204 may support transmission and/or reception of an electrical signal based on various types of communication means such as Ethernet, Bluetooth, Bluetooth low energy (BLE), ZigBee, long term evolution (LTE), or 5G new radio (NR). Specific description of the communication circuitry 204 of FIG. 2A may be applied in substantially the same manner as the description of the communication module 190 and/or the antenna module 197 of FIG. 1.

FIG. 2B illustrates a block diagram for describing operations of an electronic device for determining an execution mode of an application.

Referring to FIG. 2B, an electronic device 101 may include a window manager 210 and a home application 220. For example, the window manager 210 and/or the home application 220 refer to a unit implemented in hardware or software to perform a designated function. In an example, the window manager 210 and/or the home application 220 may be implemented as a portion of the hardware components (e.g., the processor 201, the memory 202, and/or the display 203) exemplified in FIG. 2A. In an example, the window manager 210 and/or the home application 220 may also be implemented to be stored in the memory 202 of FIG. 2A in a form of instructions for performing the designated function.

In an embodiment, the electronic device 101 may include the window manager 210. For example, the window manager 210 may be a module for managing recent task information 215 of each of applications. Hereinafter, the recent task information 215 is referred to as window information.

For example, the window manager 210 may provide window information to the home application 220 in a case of receiving a request from the home application 220. For example, the window information may include a window mode (e.g., a desktop mode or a tablet mode), a window size, a window shape, a window creation time, and/or a stacking order (e.g., z-order) of each application. An example of desktop mode may be a productivity-oriented interface (e.g., DeX mode, PC mode, Productivity Mode) provided by mobile devices when connected to an external device, a keyboard, and a mouse. The desktop mode may offer a window-based environment similar to a traditional desktop operating system. The tablet mode may refer to a standard, touch-optimized user interface that may be used during as standalone operation of the device. Although the present disclosure discloses “a tablet mode”, the tablet mode also refers to normal operation modes of non-tablet devices, such as smart phones. The window information may reflect the latest state of a window of an application. The window information may be added, removed, and/or updated according to control of the window manager 210. In an example, the window manager 210 may obtain window information for applications executed in a desktop mode 240 from a first memory area of the memory 202, and may obtain window information for applications executed in a tablet mode 230 from a second memory area of the memory 202. That is, the first memory area related to the desktop mode may be different from the second memory area related to the tablet mode. However, the present disclosure is not limited to the above examples. For example, the first memory area related to the desktop mode may be substantially the same as the second memory area related to the tablet mode.

For example, the window manager 210 may control the display 203 to display a window of an application based on the tablet mode 230 or the desktop mode 240.

For example, a window in the tablet mode 230 may include an execution screen for displaying contents of the application. For example, the window in the tablet mode 230 may include only the execution screen of the application and may not include window control buttons. However, the present disclosure is not limited thereto. For example, the window in the tablet mode 230 may further include a button for controlling the window through two or more inputs (e.g., multiple inputs or sequential inputs).

For example, a window in the desktop mode 240 may include an execution screen for displaying contents of the application and/or a control bar (or a title bar). For example, the control bar may include a title of the application and/or window control buttons. For example, the window control buttons may include buttons for controlling the window based on a single input (e.g., a tab or a click). For example, the window control buttons may include a button for minimizing a window size, a button for maximizing the window size, and/or a button for closing the window.

In an embodiment, the electronic device 101 may include the home application 220. For example, the home application 220 may be an application for managing a default screen of the electronic device 101. For example, the home application 220 may be for a recent view 225. In response to or based on an input for displaying an execution history screen, the home application 220 may provide a request for window information to the window manager 210. In response to or based on the request, the home application 220 may obtain the window information from the window manager 210. The home application 220 may control the display 203 to display the execution history screen based on the window information. The home application 220 may provide a request for changing an operation mode (e.g., the tablet mode 230 or the desktop mode 240) to the window manager 210 based on identifying an input in the execution history screen. In addition, the home application 220 may provide a request for executing an application to the window manager 210 based on identifying an input in the execution history screen.

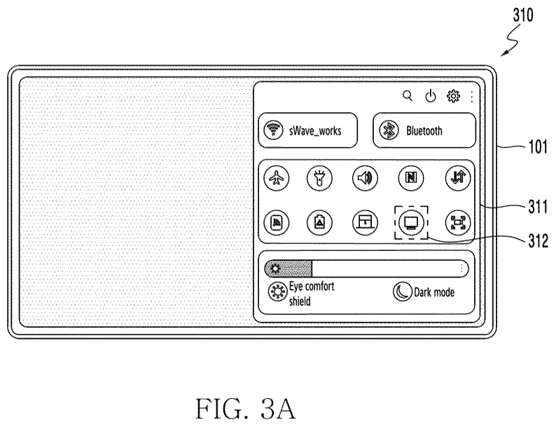

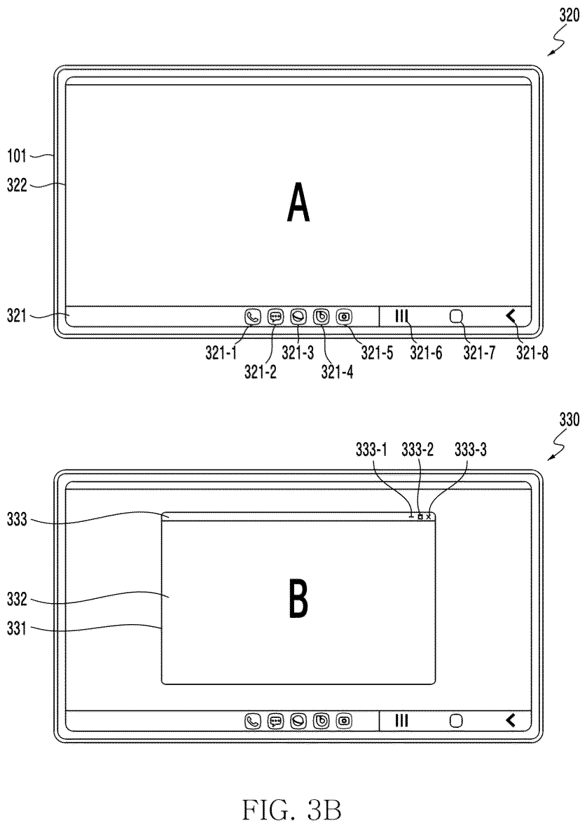

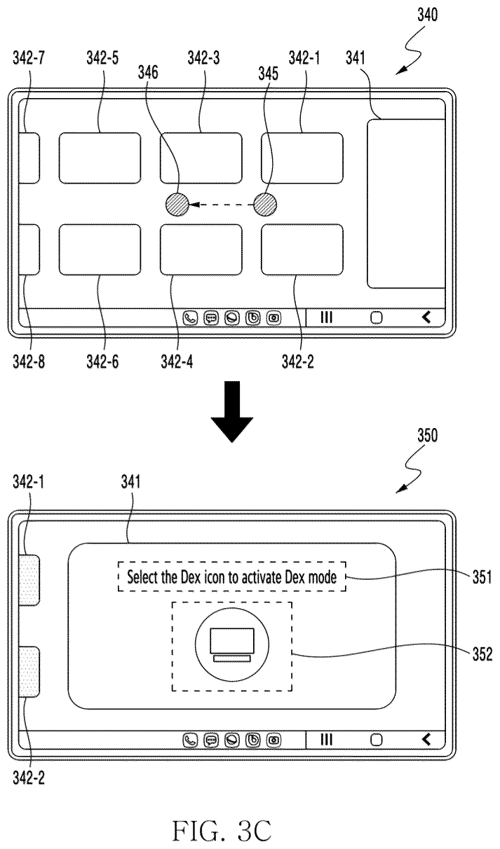

FIGS. 3A to 3C illustrate an example of activating a tablet mode or a desktop mode via a settings screen.

Referring to a situation 310 of FIG. 3A, an electronic device 101 may display a settings screen 311 via a display 203 for changing settings of the electronic device 101 based on an input. For example, the settings screen 311 may include an icon 312 for the desktop mode.

In an embodiment, the electronic device 101 may deactivate the desktop mode based on an input for the icon 312 identified while the desktop mode is activated (that is, in the desktop mode). Deactivating the desktop mode may include activating the tablet mode. In other words, the electronic device 101 is toggled between the desktop mode and the tablet mode. After activating the tablet mode, the electronic device 101 may identify an input for executing Application A. Based on the input, the electronic device 101 may display a window 322 of Application A in the tablet mode. Referring to a situation 320 of FIG. 3B, the window 322 in the tablet mode may include only an execution screen for displaying contents of Application A. That is, the window 322 in the tablet mode may not include window control buttons. Below the window 322 in the tablet mode, a task bar 321 may be displayed. For example, the task bar 321 may include icons (or shortcuts) 321-1, 321-2, 321-3, 321-4, and 321-5 for executing predefined applications, a button 321-6 for displaying an execution history screen (or a recent view), a button 321-7 for displaying a home screen, and/or a button 321-8 for displaying a previous screen. However, the task bar 321 is merely an example, and the present disclosure is not limited to the example. For example, the task bar 321 may be implemented as a gesture bar for displaying the execution history screen through a swipe input. In an example, an area including the button 321-6 for displaying the execution history screen, the button 321-7 for displaying the home screen, and the button 321-8 for displaying the previous screen may be referred to as a navigation bar.

In an embodiment, the electronic device 101 may activate the desktop mode based on an input for the icon 312 identified while the desktop mode is deactivated. Activating the desktop mode may include deactivating the tablet mode. In other words, the electronic device 101 is switched from the tablet mode to the desktop mode. After activating the desktop mode, the electronic device 101 may identify an input for executing Application B. Based on the input, the electronic device 101 may display a window 331 of Application B in the desktop mode. Referring to a situation 330 of FIG. 3B, the window 331 in the desktop mode may include an execution screen 332 for displaying contents of Application B and a control bar 333. For example, the control bar 333 may include a button 333-1 for minimizing a window size, a button 333-2 for maximizing the window size, and/or a button 333-3 for closing the window.

As described above, switching between the desktop mode and the tablet mode may be activated/deactivated by toggling the icon 312 of the settings screen 311. In one embodiment, the desktop mode may be activated when the electronic device 101 and an external electronic device are connected by a wire or wirelessly, and the desktop mode may be deactivated when the connection is released. However, the method described above may not satisfy user requirements for rapid switching between the desktop mode and the tablet mode. To satisfy user requirements for rapid switching between the desktop mode and the tablet mode, the execution history screen may be used as described below.

For example, in the situation 320 of FIG. 3B, the electronic device 101 may identify an input for the button 321-6. Referring to FIG. 3C, in a situation 340, the electronic device 101 may display the execution history screen based on the input for the button 321-6. The execution history screen may include a section 341 for displaying images of applications executed in the desktop mode and images 342-1, 342-2, 342-3, 342-4, 342-5, 342-6, 342-7, and 342-8 of applications executed in the tablet mode. The number of images of applications executed in the tablet mode is not limited to that illustrated in FIG. 3C.

For example, in the situation 340 of FIG. 3C, the electronic device 101 may identify a leftward swipe input. The leftward swipe input may be a swipe input from a contact start point 345 to a contact release point 346. Based on the leftward swipe input, the electronic device 101 may control the display 203 such that a displayed area of the execution history screen moves rightward. As the displayed area of the execution history screen moves rightward, a display ratio of the section 341 may increase.

For example, in a situation 350 of FIG. 3C, the electronic device 101 may display the execution history screen updated according to movement of the displayed area of the execution history screen. When there are no applications executed in the desktop mode, the section 341 in the updated execution history screen may include text 351 and/or an image 352 for guiding activation of the desktop mode. The electronic device 101 may deactivate the tablet mode and activate the desktop mode based on identifying an input related to the section 341. In an example, the input related to the section 341 may be a touch input on at least a portion of an area occupied by the section 341. For example, an application executed while the desktop mode is activated (that is, in or during the desktop mode) may be displayed based on the desktop mode. In an example, when Application B is executed while the desktop mode is activated, the window of Application B may be displayed as illustrated in the situation 330 of FIG. 3B.

Hereinafter, an electronic device, a method, and a non-transitory computer readable storage medium for facilitating access to applications executed in the desktop mode or the tablet mode by displaying a section related to the desktop mode and a section related to the tablet mode together in the execution history screen are described.

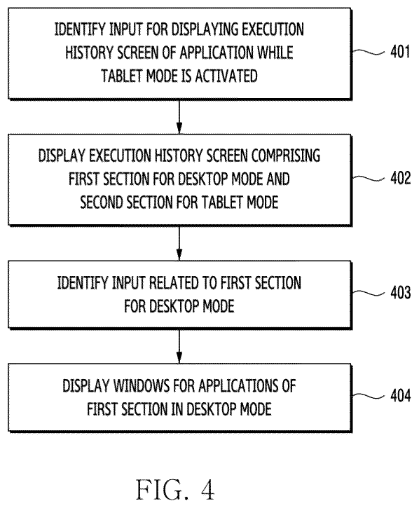

FIG. 4 illustrates a flowchart indicating operations of an electronic device for displaying windows in a desktop mode. The operations of FIG. 4 may be performed by the electronic device 101 of FIGS. 1, 2A, and 2B. For example, at least a portion of the operations may be controlled by a processor 201 of the electronic device 101. Hereinafter, each of the operations may be performed sequentially, but is not necessarily performed in sequence. For example, an order of each of the operations may be changed and/or at least two operations may be performed in parallel.

Referring to FIG. 4, in operation 401, the electronic device 101 according to an embodiment may identify an input for displaying an execution history screen of an application while a tablet mode is activated (that is, in or during the tablet mode). For example, the execution history screen may provide a list of applications executed by the electronic device 101 to a user. The applications included in the list may include applications currently being executed by the electronic device 101 and/or applications that were executed and then terminated by the electronic device 101. In an example, the execution history screen may be referred to as a recent view or another term having an equivalent technical or functional meaning thereto.

In an embodiment, a window of an application may be displayed based on the desktop mode or the tablet mode. For example, the desktop mode and the tablet mode may be independently controlled by one launcher (e.g., a home application 220). For example, the desktop mode may have a first user interface (UI) configuration, and the tablet mode may have a second UI configuration different from the first UI configuration.

For example, a window in the desktop mode having the first UI configuration may include an execution screen for displaying contents of the application and/or a control bar (or a title bar). For example, the control bar may include a title of the application and/or window control buttons. For example, the window control buttons may include buttons for controlling the window based on a single input (e.g., a tab or a click). For example, the window control buttons may include a button for minimizing a window size, a button for maximizing the window size, and/or a button for closing the window. In an example, the electronic device 101 may minimize the window of the application based on a single input for the button for minimizing the window size. When the window of the application is minimized, the window of the application may be removed from a display area of a display 203. In an example, the electronic device 101 may maximize the window of the application based on a single input for the button for maximizing the window size. In an example, the electronic device 101 may terminate the application based on a single input for the button for closing the window. In an example, the desktop mode may be referred to as a first mode, a first display mode, a first window mode, a first execution mode, a first operation mode, or another term having an equivalent technical or functional meaning thereto. For example, windows of applications executed in the desktop mode may overlap. The overlapped windows may be displayed according to a stacking order. In an example, in an area in which a first window and a second window overlap, the first window having a higher stacking order may be displayed, and the second window having a lower stacking order may not be displayed.

For example, a window in the tablet mode having the second UI configuration may include an execution screen for displaying the contents of the application. For example, the window in the tablet mode may include the execution screen of the application only but may not include the window control buttons. However, the present disclosure is not limited to the above example. For example, the window in the tablet mode may further include a button for controlling the window through two or more inputs (e.g., multiple inputs or sequential inputs). In an example, based on identifying a first input for the button, the electronic device 101 may display a menu indicating options (e.g., full screen and/or split view) for controlling the window. Based on identifying a second input for an option displayed in the menu, the electronic device 101 may perform window control corresponding to the option. In an example, the tablet mode may be referred to as a second mode, a second display mode, a second window mode, a second execution mode, a second operation mode, or another term having an equivalent technical or functional meaning thereto. For example, windows of applications executed in the tablet mode may not overlap. For example, a window of an application executed in the tablet mode may be displayed in full screen. However, the present disclosure is not limited to the above example. For example, a window of an application executed in the tablet mode may be displayed on a portion of the screen, not on the whole area of the screen.

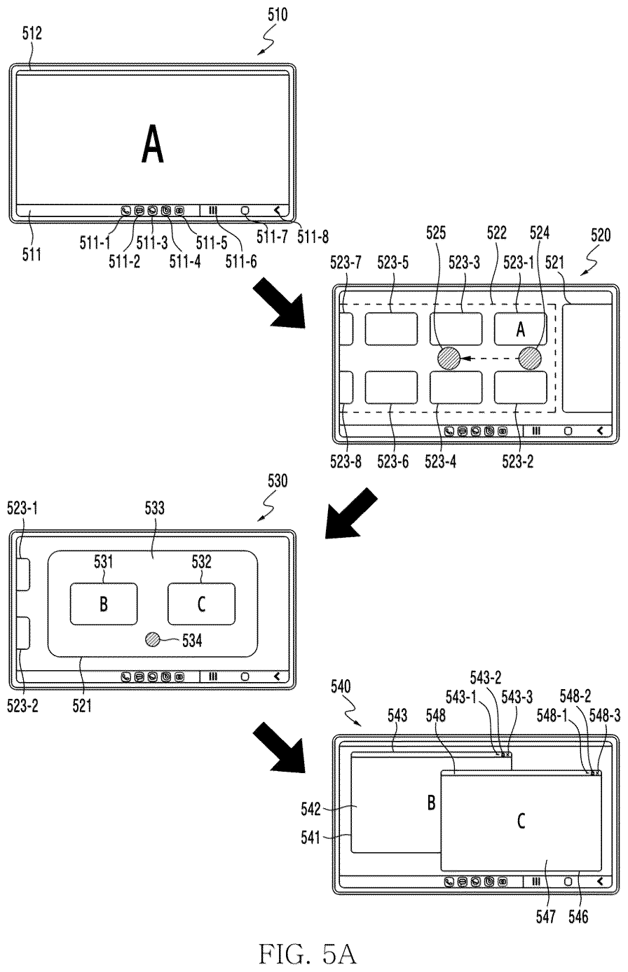

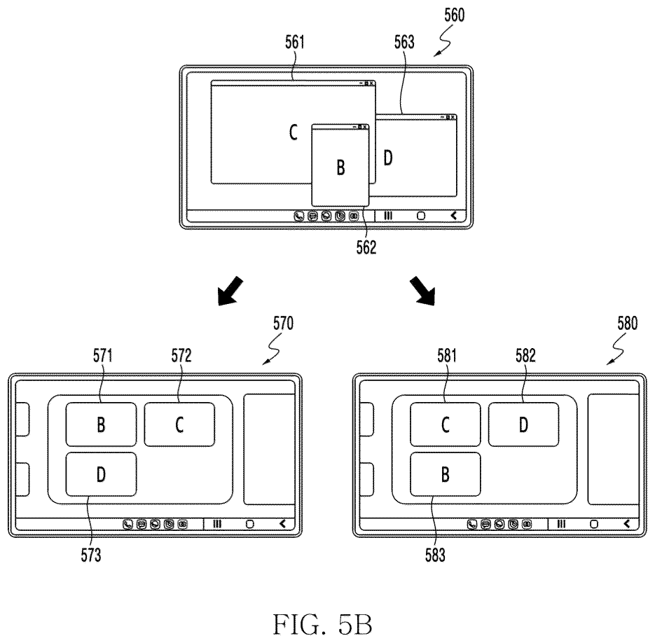

In an embodiment, the electronic device 101 may display an object for identifying an input for displaying the execution history screen on at least a portion of a current screen. In an example, the object may be an object for identifying a touch input. In a case of an object for identifying a touch input, it may be implemented in a button form (e.g., a button 511-6 of FIG. 5A). For another example, the object may be an object for identifying a swipe input. The object for identifying a swipe input may be implemented in a bar form (e.g., a gesture bar). The object for identifying an input for displaying the execution history screen may be configured as the button and/or the bar according to user settings.

In an embodiment, the electronic device 101 may identify an input for the object while the tablet mode is activated (that is, in or during the tablet mode). Based on identifying the input, the electronic device 101 may obtain window information from memory 202. For example, the window information may include a window mode (e.g., the desktop mode or the tablet mode), a window size, a window shape, a window creation time, and/or a stacking order (e.g., z-order) of each application. The window information may reflect the latest state of a window of an application. In an example, the electronic device 101 may obtain window information for the applications executed in the desktop mode from a first memory area of the memory 202, and may obtain window information for the applications executed in the tablet mode from a second memory area of the memory 202. That is, the first memory area related to the desktop mode may be different from the second memory area related to the tablet mode. However, the present disclosure is not limited to the above example. For example, the first memory area related to the desktop mode may be substantially the same as the second memory area related to the tablet mode.

In operation 402, the electronic device 101 according to an embodiment may display the execution history screen comprising a first section for the desktop mode and a second section for the tablet mode. In an example, a section may be referred to as a field, a workspace, or another term having an equivalent technical or functional meaning thereto.

In an embodiment, the electronic device 101 may display the execution history screen comprising the first section for displaying images of the applications executed in the desktop mode and the second section for displaying images of the applications executed in the tablet mode based on the window information obtained from the memory 202. In an example, an image of an application displayed within the first section and/or the second section may be a snapshot, a captured image, or a thumbnail image of the application execution screen.

In an embodiment, the first section for the desktop mode may be displayed via the display 203, but the second section for the tablet mode may not be displayed via the display 203. That is, the second section for the tablet mode may be a logically defined area, and may be invisible to the user. However, the present disclosure is not limited to the above example. For example, the first section for the desktop mode and the second section for the tablet mode may be respectively displayed or not displayed via the display 203. For example, the first section and the second section may be individually controlled by one home application 220.

In an embodiment, the first section and the second section may be logically separated in the execution history screen. For example, since the first memory area storing the window information of the applications related to the first section and the second memory area storing the window information of the applications related to the second section are different, the first section and the second section may be logically separated. In an example, since the first section and the second section are logically separated, the electronic device 101 may ignore a drag and drop input from the first section to the second section. In an example, the electronic device 101 may ignore a drag and drop input from the second section to the first section. However, the present disclosure is not limited to the above example. The electronic device 101 may change a mode of an application from the desktop mode to the tablet mode based on a drag and drop input from the first section to the second section. The electronic device 101 may change a mode of an application from the tablet mode to the desktop mode based on a drag and drop input from the second section to the first section.

In an embodiment, in an initial screen of the execution history screen displayed in response to or based on an input identified while the tablet mode is activated, an area occupied by the first section for the desktop mode may be smaller than an area occupied by the second section for the tablet mode. However, the present disclosure is not limited to the above example. For example, in the initial screen of the execution history screen, the area occupied by the first section may be larger than the area occupied by the second section.

In an embodiment, the electronic device 101 may identify an input for object navigation while the execution history screen is displayed. The electronic device 101 may update the execution history screen based on the input for object navigation.

For example, the execution history screen may comprise the first section on a right side and the second section on a left side. The electronic device 101 may control the display 203 such that a displayed area of the execution history screen moves rightward based on a leftward swipe input. The leftward swipe input may correspond to a gesture of moving a finger in contact with the display 203 from right to left. As the displayed area of the execution history screen moves rightward, a display ratio of the first section may increase, and a display ratio of the second section may decrease. The display ratio of the first section may indicate a ratio of the area occupied by the first section in the execution history screen. The display ratio of the second section may indicate a ratio of the area occupied by the second section in the execution history screen.

In operation 403, the electronic device 101 according to an embodiment may identify an input related to the first section for the desktop mode. For example, based on the input related to the first section, the electronic device 101 may deactivate the tablet mode and activate the desktop mode. A window of an application executed after the desktop mode is activated may be displayed in the desktop mode. In an example, the input related to the first section may be an input selecting an image of an application displayed within the first section. For another example, the input related to the first section may be an input for a remaining area within the first section excluding an area in which the images of the applications are displayed.

In operation 404, the electronic device 101 according to an embodiment may display the windows for the applications of the first section in the desktop mode.

In an embodiment, the electronic device 101 may determine a stacking order of the applications to display the windows for the applications of the first section in the desktop mode. For example, the stacking order may indicate an order in which the windows of the applications are displayed. In an example, when a stacking order of a first application is higher than a stacking order of a second application, a window of the first application may be overlaid on a window of the second application. In this case, the window of the first application may be displayed with priority over the window of the second application. For example, in an area in which the window of the first application and the window of the second application overlap, the window of the first application may be displayed, and the window of the second application may not be displayed.

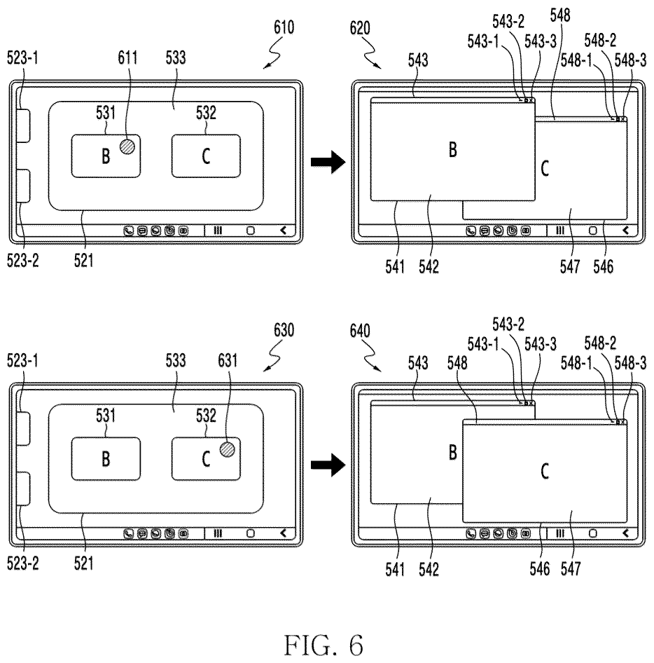

For example, the electronic device 101 may determine the stacking order based on an input related to the first section and/or the window information. For example, a stacking order included in the window information may correspond to an order in which the applications were executed. For example, when an input selecting an image of an application displayed within the first section is identified, the electronic device 101 may change (or update) the stacking order based on the window information, such that the corresponding application has the highest stacking order. An example of such a case is described in FIG. 5A. For example, when an input for the remaining area within the first section excluding the area in which the images of the applications are displayed is identified, the electronic device 101 may determine the stacking order based on the window information. An example of such a case is described in FIG. 6.

In an embodiment, the electronic device 101 may display the windows for the applications of the first section in the desktop mode based on the determined stacking order. The windows in the desktop mode may include an execution screen of each application and window control buttons.

FIGS. 5A and 5B illustrate an example of displaying windows in a desktop mode.

Referring to FIG. 5A, in a situation 510, while a tablet mode is activated, an electronic device 101 may display a task bar 511 and a window 512 of Application A via a display 203.

For example, the task bar 511 may include icons (or shortcuts) 511-1, 511-2, 511-3, 511-4, and 511-5 for executing predefined applications, a button 511-6 for displaying an execution history screen (or a recent view), a button 511-7 for displaying a home screen, and/or a button 511-8 for displaying a previous screen. However, the present disclosure is not limited thereto. For example, the task bar 511 may be implemented as a gesture bar for displaying the execution history screen through a swipe input.

For example, the window 512 of Application A may be displayed in the tablet mode. The window 512 in the tablet mode may include only an execution screen for displaying contents of Application A. However, the present disclosure is not limited thereto. For example, the window 512 in the tablet mode may further include a button for controlling the window 512 through two or more inputs.

For example, in the situation 510 of FIG. 5A, the electronic device 101 may identify an input for the button 511-6.

In a situation 520, the electronic device 101 may display the execution history screen based on the input for the button 511-6. The execution history screen may comprise a first section 521 for displaying images of applications executed in the desktop mode and a second section 522 for displaying images 523-1, 523-2, 523-3, 523-4, 523-5, 523-6, 523-7, and 523-8 of applications executed in the tablet mode. The first section 521 and the second section 522 may be visually separated. The number of images included within the first section 521 and/or the second section 522 is not limited to that illustrated in FIG. 5A. In an example, an image of an application may be referred to as an application (app) card or another term having an equivalent technical or functional meaning thereto. An area corresponding to the second section 522 displayed in FIG. 5 is merely an example, and the present disclosure is not limited thereto. For example, the area of the second section 522 may indicate an area excluding the first section 521.

For example, an image of an application displayed within the first section and/or the second section may be a snapshot, a captured image, or a thumbnail image of the application execution screen.

For example, the first section 521 for the desktop mode may be displayed via the display 203, but the second section 522 for the tablet mode may not be displayed via the display 203. That is, the second section 522 for the tablet mode may be invisible to a user. However, the present disclosure is not limited thereto.

For example, when the execution history screen is displayed in a state in which the tablet mode is activated, an area occupied by the first section 521 in an initial screen of the execution history screen may be smaller than an area occupied by the second section 522. However, the present disclosure is not limited thereto. For example, the area occupied by the first section 521 in the initial screen may be larger than the area occupied by the second section 522.

For example, the electronic device 101 may update the execution history screen based on an input for object navigation. In the example illustrated in FIG. 5A, the electronic device 101 may identify a leftward swipe input. The leftward swipe input may be a swipe input from a contact start point 524 to a contact release point 525. Based on the leftward swipe input, the electronic device 101 may control the display 203 such that a displayed area of the execution history screen moves rightward. As the displayed area of the execution history screen moves rightward, a display ratio of the first section 521 may increase, and a display ratio of the second section 522 may decrease.

In a situation 530, the electronic device 101 may display the execution history screen updated according to movement of the displayed area of the execution history screen. The updated execution history screen may display the first section 521 and at least a portion of the images of the applications executed in the tablet mode (e.g., at least a portion of the image 523-1 and at least a portion of the image 523-2). For example, the first section 521 may include an image 531 of Application B and an image 532 of Application C. Application B and Application C may be applications executed in the desktop mode.

In the example illustrated in FIG. 5A, the electronic device 101 may identify an input for a remaining area 533 within the first section 521 excluding an area in which the image 531 and the image 532 are displayed. For example, the electronic device 101 may identify an input at a contact point 534. Based on the input at the contact point 534, the electronic device 101 may deactivate the tablet mode and activate the desktop mode.

In a situation 540, the electronic device 101 may display a window 541 of Application B and a window 546 of Application C based on the input at the contact point 534. For example, the electronic device 101 may identify that a stacking order (or z-order) of the window 541 is lower than a stacking order of the window 546, from window information stored in memory 202. Since the stacking order of the window 541 is lower than the stacking order of the window 546, the window 546 may be overlaid on the window 541.

For example, the window 541 and the window 546 may be displayed based on the desktop mode. For example, the window 541 in the desktop mode may include an execution screen 542 for displaying contents of Application B and a control bar 543. The control bar 543 may include a button 543-1 for minimizing a window size, a button 543-2 for maximizing the window size, and/or a button 543-3 for closing the window. For example, the window 546 in the desktop mode may include an execution screen 547 for displaying contents of Application C and a control bar 548. The control bar 548 may include a button 548-1 for minimizing a window size, a button 548-2 for maximizing the window size, and/or a button 548-3 for closing the window.

Referring to the situation 530 and the situation 540, deployment of the image 531 and the image 532 displayed within the first section 521 may be based on deployment of application windows. For example, the deployment of the image 531 of Application B and the image 532 of Application C in the situation 530 may correspond to the deployment of the window 541 and the window 546 in the situation 540. However, the present disclosure is not limited thereto. The deployment of the images displayed within the first section may be based on a stacking order (or execution order) of the applications or the deployment of the application windows. A more detailed description is described in FIG. 5B.

Referring to a situation 560 of FIG. 5B, in the situation 560, Application B, Application C, and Application D may be executed in the desktop mode. A stacking order of Application B may be higher than stacking orders of Application C and Application D. Accordingly, a window 562 of Application B may be overlaid on a window 561 of Application C and a window 563 of Application D. The stacking order of Application C may be higher than the stacking order of Application D. Accordingly, the window 561 of Application C may be overlaid on the window 563 of Application D.

A situation 570 of FIG. 5B illustrates deployment of images based on the stacking order. When an input for displaying the execution history screen is identified in the situation 560, the electronic device 101 may display images 571, 572, and 573 within the first section 521 based on the stacking order. For example, the deployment of the images in the situation 570 may correspond to the stacking orders of the windows in the situation 560.

A situation 580 of FIG. 5B illustrates deployment of images based on the deployment of the application windows. When an input for displaying the execution history screen is identified in the situation 560, the electronic device 101 may display images 581, 582, and 583 within the first section 521 based on the deployment of the application windows. For example, the deployment of the images in the situation 580 may correspond to the deployment of the windows in the situation 560.

FIG. 6 illustrates an example of displaying windows in a desktop mode. A situation 610 and a situation 630 of FIG. 6 may correspond to the situation 530 of FIG. 5A.

The situation 610 and a situation 620 of FIG. 6 describe operations of an electronic device 101 when an input for an image 531 of Application B is identified.

In the situation 610, the electronic device 101 may display an execution history screen. The execution history screen may display a first section 521 and at least a portion of images 523-1 and 523-2 of applications executed in a tablet mode. The first section 521 may include images of applications executed in the desktop mode. For example, the first section 521 may include the image 531 of Application B and an image 532 of Application C. In an example, an image of an application may be a snapshot, a captured image, or a thumbnail image of the application execution screen.

In the example illustrated in FIG. 6, the electronic device 101 may identify an input for the image 531. For example, the electronic device 101 may identify an input at a contact point 611. Based on the input at the contact point 611, the electronic device 101 may deactivate the tablet mode and activate the desktop mode.

In the situation 620, the electronic device 101 may display a window 541 of Application B and a window 546 of Application C based on the input for the image 531.

For example, since the input for the image 531 is an input for selecting Application B, the window 541 of Application B may be overlaid on the window 546 of Application C. For example, even when a stacking order of Application C is higher than a stacking order of Application B according to window information, the electronic device 101 may display the window 541 of Application B with priority over the window 546 of Application C based on the input selecting Application B.

For example, the window 541 and the window 546 may be displayed based on the desktop mode. For example, the window 541 in the desktop mode may include an execution screen 542 for displaying contents of Application B and a control bar 543. The control bar 543 may include a button 543-1 for minimizing a window size, a button 543-2 for maximizing the window size, and/or a button 543-3 for closing the window. For example, the window 546 in the desktop mode may include an execution screen 547 for displaying contents of Application C and a control bar 548. The control bar 548 may include a button 548-1 for minimizing a window size, a button 548-2 for maximizing the window size, and/or a button 548-3 for closing the window.

The situation 630 and a situation 640 of FIG. 6 describe operations of the electronic device 101 when an input for the image 532 of Application C is identified.

In the situation 630, the electronic device 101 may display the execution history screen. The execution history screen may display the first section 521 and at least a portion of the images 523-1 and 523-2 of the applications executed in the tablet mode. The first section 521 may include images of applications executed in the desktop mode. For example, the first section 521 may include the image 531 of Application B and the image 532 of Application C.

In the example illustrated in FIG. 6, the electronic device 101 may identify an input for the image 532. For example, the electronic device 101 may identify an input at a contact point 631. Based on the input at the contact point 631, the electronic device 101 may deactivate the tablet mode and activate the desktop mode.

In the situation 640, the electronic device 101 may display the window 541 of Application B and the window 546 of Application C based on the input for the image 532.

For example, since the input for the image 532 is an input for selecting Application C, the window 546 of Application C may be overlaid on the window 541 of Application B. For example, even when the stacking order of Application B is higher than the stacking order of Application C based on the window information, the electronic device 101 may display the window 546 of Application C with priority over the window 541 of Application B based on the input selecting Application C.

For example, the window 541 and the window 546 may be displayed based on the desktop mode. For example, the window 541 in the desktop mode may include the execution screen 542 for displaying the contents of Application B and the control bar 543. The control bar 543 may include the button 543-1 for minimizing the window size, the button 543-2 for maximizing the window size, and/or the button 543-3 for closing the window. For example, the window 546 in the desktop mode may include the execution screen 547 for displaying the contents of Application C and the control bar 548. The control bar 548 may include the button 548-1 for minimizing the window size, the button 548-2 for maximizing the window size, and/or the button 548-3 for closing the window.

As described above, when an input selecting an image within the first section 521 is identified, the electronic device 101 may control a display 203 such that a window of an application corresponding to the selected image is displayed at the top. In addition, as described in FIG. 5A, when an input for a remaining area 533 within the first section 521 excluding an area in which the images are displayed is identified, the electronic device 101 may display the windows based on the stacking order identified by the window information.

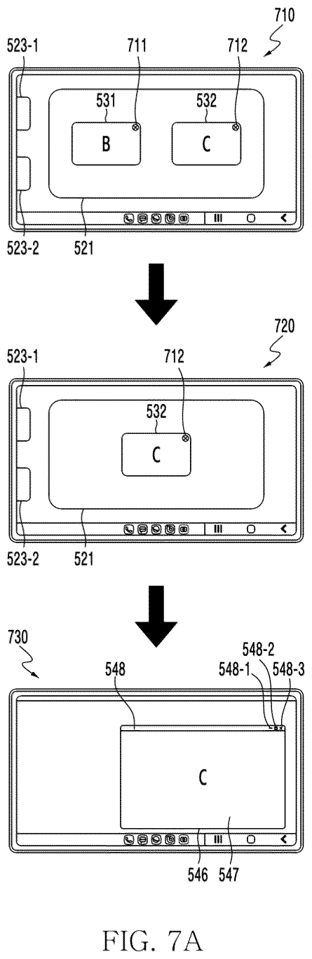

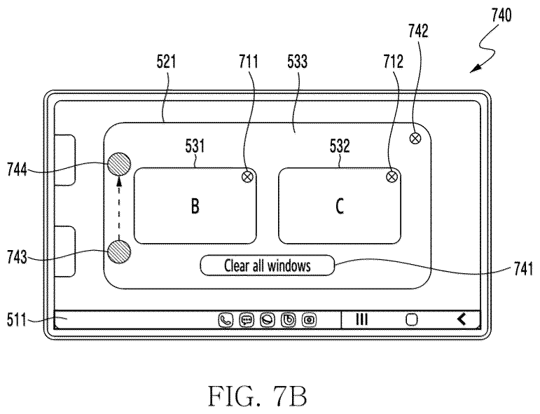

FIGS. 7A and 7B illustrate an example of displaying a window in a desktop mode.

Referring to FIG. 7A, in a situation 710, an electronic device 101 may identify a long press input for a first section 521. Based on the long press input for the first section 521, the electronic device 101 may display a button within images 531 and 532 of the first section 521 for removing a corresponding image from the first section 521. For example, the electronic device 101 may display a button 711 within the image 531 of Application B for removing the image 531 from the first section 521. For example, the electronic device 101 may display a button 712 within the image 532 of Application C for removing the image 532 from the first section 521. Thereafter, the electronic device 101 may identify an input for the button 711.

In a situation 720, based on the input for the button 711, the electronic device 101 may remove the image 531 of Application B from the first section 521. After the image 531 is removed from the first section 521, the electronic device 101 may identify an input related to the first section 521.

In a situation 730, based on the input related to the first section 521, the electronic device 101 may display a window 546 of Application C. For example, the window 546 may be displayed based on the desktop mode. The window 546 in the desktop mode may include an execution screen 547 for indicating contents of Application C and a control bar 548. The control bar 548 may include a button 548-1 for minimizing a window size, a button 548-2 for maximizing the window size, and/or a button 548-3 for closing the window.

Although FIG. 7A describes an example in which a button for removing an image from the first section 521 is displayed based on a long press input, the present disclosure is not limited to the above example. For example, images of applications included in the first section 521 may include a button for removing the corresponding image without a separate input.

Referring to a situation 740 of FIG. 7B, the first section 521 may include, without a separate input, a button 711 for removing the image 531 of Application B from the first section 521, a button 712 for removing the image 532 of Application C from the first section 521, a button 741 including text for guiding removal of the images 531 and 532 of the applications from the first section 521, and/or a button 742 for removing the first section 521.

In an example, the electronic device 101 may remove the image 531 of Application B from the first section 521 based on an input for the button 711. In an example, the electronic device 101 may remove the image 532 of Application C from the first section 521 based on an input for the button 712. In an example, the electronic device 101 may remove the image 531 of Application B and the image 532 of Application C from the first section 521 based on an input for the button 741. In an example, the electronic device 101 may remove the first section 521 based on an input for the button 742. FIG. 7B illustrates examples of removing an image of an application from the first section 521 and removing the first section 521 based on an input for a button. The present disclosure is not limited to the above examples of FIG. 7B.

For example, the electronic device 101 may identify an input selecting the image 531 of Application B. The input selecting the image 531 may be a long press input. After identifying the input selecting the image 531 of Application B, the electronic device 101 may identify a swipe input. In an example, the swipe input may be a swipe input from a contact start point 743 to a contact release point 744. Based on the swipe input, the electronic device 101 may remove the image 531 of Application B from the first section 521.

For example, the electronic device 101 may identify an input selecting the image 532 of Application C. The input selecting the image 532 may be a long press input. After identifying the input selecting the image 532 of Application C, the electronic device 101 may identify a swipe input. In an example, the swipe input may be a swipe input from the contact start point 743 to the contact release point 744. Based on the swipe input, the electronic device 101 may remove the image 532 of Application C from the first section 521.

For example, the electronic device 101 may identify inputs selecting the image 531 of Application B and the image 532 of Application C. Each of the inputs may be a long press input. After identifying the inputs, the electronic device 101 may identify a swipe input. In an example, the swipe input may be a swipe input from the contact start point 743 to the contact release point 744. Based on the swipe input, the electronic device 101 may remove the image 531 of Application B and the image 532 of Application C from the first section 521.

For example, the electronic device 101 may identify an input selecting the first section 521. The input selecting the first section 521 may be a long press input for a remaining area 533 within the first section 521 excluding an area in which the image 531 and the image 532 are displayed. After identifying the input selecting the first section 521, the electronic device 101 may identify a swipe input. In an example, the swipe input may be a swipe input from the contact start point 743 to the contact release point 744. Based on the swipe input, the electronic device 101 may remove the first section 521.

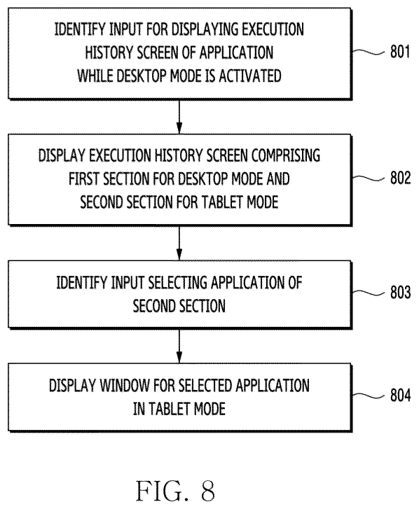

FIG. 8 illustrates a flowchart indicating operations of an electronic device for displaying windows in a tablet mode. The operations of FIG. 8 may be performed by the electronic device 101 of FIGS. 1, 2A, and 2B. For example, at least a portion of the operations may be controlled by a processor 201 of the electronic device 101. Hereinafter, each of the operations may be performed sequentially, but is not necessarily performed in sequence. For example, an order of each of the operations may be changed and/or at least two operations may be performed in parallel.

Referring to FIG. 8, in operation 801, the electronic device 101 according to an embodiment may identify an input for displaying an execution history screen of an application while a desktop mode (for example, Dex mode) is activated. For example, the execution history screen may provide a list of applications executed by the electronic device 101 to a user. The applications included in the list may include applications currently being executed by the electronic device 101 and/or applications that were executed and then terminated by the electronic device 101. In an example, the execution history screen may be referred to as a recent view or another term having an equivalent technical or functional meaning thereto.

In an embodiment, a window of an application may be displayed based on the desktop mode or a tablet mode. For example, the desktop mode and the tablet mode may be independently controlled by one launcher (e.g., a home application 220). For example, the desktop mode may have a first user interface (UI) configuration, and the tablet mode may have a second UI configuration different from the first UI configuration.

For example, a window in the desktop mode having the first UI configuration may include an execution screen for displaying contents of the application and/or a control bar (or a title bar). For example, the control bar may include a title of the application and/or window control buttons. For example, the window control buttons may include buttons for controlling the window based on a single input (e.g., a tab or a click). For example, the window control buttons may include a button for minimizing a window size, a button for maximizing the window size, and/or a button for closing the window. In an example, the electronic device 101 may minimize the window of the application based on a single input for the button for minimizing the window size. When the window of the application is minimized, the window of the application may be removed from a display area of a display 203. In an example, the electronic device 101 may maximize the window of the application based on a single input for the button for maximizing the window size. In an example, the electronic device 101 may terminate the application based on a single input for the button for closing the window. In an example, the desktop mode may be referred to as a first mode, a first display mode, a first window mode, a first execution mode, a first operation mode, or another term having an equivalent technical or functional meaning thereto. For example, windows of applications executed in the desktop mode may overlap. The overlapped windows may be displayed based on a stacking order. In an example, in an area in which a first window and a second window overlap, the first window having a higher stacking order may be displayed, and the second window having a lower stacking order may not be displayed.

For example, a window in the tablet mode having the second UI configuration may include an execution screen for displaying the contents of the application. For example, the window in the tablet mode may include only the execution screen of the application and may not include the window control buttons. However, the present disclosure is not limited thereto. For example, the window in the tablet mode may further include a button for controlling the window through two or more inputs (e.g., multiple inputs or sequential inputs). In an example, based on identifying a first input for the button, the electronic device 101 may display a menu indicating options (e.g., full screen and/or split view) for controlling the window. Based on identifying a second input for an option displayed in the menu, the electronic device 101 may perform window control corresponding to the option. In an example, the tablet mode may be referred to as a second mode, a second display mode, a second window mode, a second execution mode, a second operation mode, or another term having an equivalent technical or functional meaning thereto. For example, windows of applications executed in the tablet mode may not overlap. For example, a window of an application executed in the tablet mode may be displayed in full screen. However, the present disclosure is not limited thereto. For example, a window of an application executed in the tablet mode may be displayed on at least a portion of a screen.

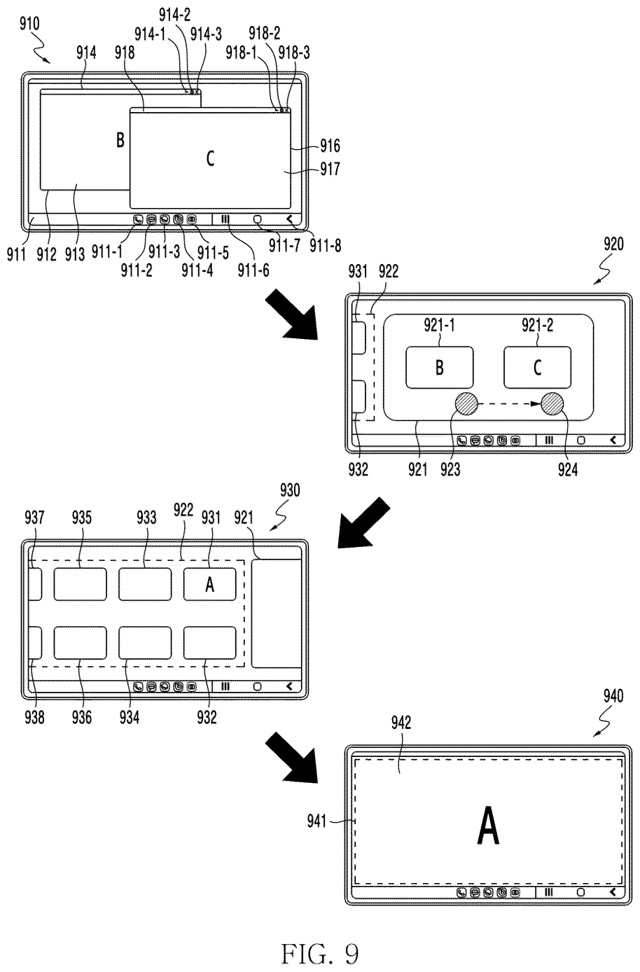

In an embodiment, the electronic device 101 may display an object for identifying an input for displaying the execution history screen on at least a portion of a current screen. In an example, the object may be an object for identifying a touch input. In a case of an object for identifying a touch input, it may be implemented in a button form (e.g., a button 911-6 of FIG. 9). For another example, the object may be an object for identifying a swipe input. The object for identifying the swipe input may be implemented in a bar form (e.g., a gesture bar). The object for identifying an input for displaying the execution history screen may be configured as the button and/or the bar according to user settings.

In an embodiment, the electronic device 101 may identify an input for the object while the desktop mode is activated. Based on identifying the input, the electronic device 101 may obtain window information from memory 202. For example, the window information may include a window mode (e.g., the desktop mode or the tablet mode), a window size, a window shape, a window creation time, and/or a stacking order (e.g., z-order) of each application. The window information may reflect the latest state of a window of an application. In an example, the electronic device 101 may obtain window information for the applications executed in the desktop mode from a first memory area of the memory 202, and may obtain window information for the applications executed in the tablet mode from a second memory area of the memory 202. That is, the first memory area related to the desktop mode may be different from the second memory area related to the tablet mode. However, the present disclosure is not limited thereto. For example, the first memory area related to the desktop mode may be substantially the same as the second memory area related to the tablet mode.

In operation 802, the electronic device 101 according to an embodiment may display the execution history screen comprising a first section for the desktop mode and a second section for the tablet mode. In an example, a section may be referred to as a field, a workspace, or another term having an equivalent technical or functional meaning thereto.

In an embodiment, the electronic device 101 may display the execution history screen comprising the first section for displaying images of the applications executed in the desktop mode and the second section for displaying images of the applications executed in the tablet mode based on the window information obtained from the memory 202. In an example, an image of an application displayed within the first section and/or the second section may be a snapshot, a captured image, or a thumbnail image of the application execution screen.

In an embodiment, the first section for the desktop mode may be displayed via the display 203, but the second section for the tablet mode may not be displayed via the display 203. That is, the second section for the tablet mode may be a logically defined area, and may be invisible to the user. However, the present disclosure is not limited thereto. For example, the first section for the desktop mode and the second section for the tablet mode may be respectively displayed or not displayed via the display 203. For example, the first section and the second section may be individually controlled by one home application 220.

In an embodiment, the first section and the second section may be logically separated in the execution history screen. For example, since the first memory area storing the window information of the applications related to the first section and the second memory area storing the window information of the applications related to the second section are different, the first section and the second section may be logically separated. In an example, since the first section and the second section are logically separated, the electronic device 101 may ignore a drag and drop input from the first section to the second section. In an example, the electronic device 101 may ignore a drag and drop input from the second section to the first section. However, the present disclosure is not limited thereto. The electronic device 101 may change a mode of an application from the desktop mode to the tablet mode based on a drag and drop input from the first section to the second section. The electronic device 101 may change a mode of an application from the tablet mode to the desktop mode based on a drag and drop input from the second section to the first section.

In an embodiment, in an initial screen of the execution history screen displayed in response to or based on an input identified while the desktop mode is activated, an area occupied by the first section for the desktop mode may be larger than an area occupied by the second section for the tablet mode. However, the present disclosure is not limited thereto. For example, in the initial screen of the execution history screen, the area occupied by the first section may be smaller than the area occupied by the second section.

In an embodiment, the electronic device 101 may identify an input for object navigation while the execution history screen is displayed. The electronic device 101 may update the execution history screen based on the input for object navigation.

For example, the execution history screen may comprise the first section on a right side and the second section on a left side. The electronic device 101 may control the display 203 such that a displayed area of the execution history screen moves leftward based on a rightward swipe input. The rightward swipe input may correspond to a gesture of moving a finger in contact with the display 203 from left to right. As the displayed area of the execution history screen moves leftward, a display ratio of the first section may decrease, and a display ratio of the second section may increase. The display ratio of the first section may indicate a ratio of the area occupied by the first section in the execution history screen. The display ratio of the second section may indicate a ratio of the area occupied by the second section in the execution history screen.

In operation 803, the electronic device 101 according to an embodiment may identify an input selecting an application of the second section for the tablet mode. For example, the electronic device 101 may identify an input selecting one application among the applications within the second section. Based on identifying the input, the electronic device 101 may deactivate the desktop mode and activate the tablet mode. A window of an application executed after the tablet mode is activated may be displayed in the tablet mode.

In operation 804, the electronic device 101 according to an embodiment may display a window for the selected application in the tablet mode. For example, the window in the tablet mode may include only an execution screen for displaying contents of the application. However, the present disclosure is not limited to the above example. For example, the window in the tablet mode may further include a button for controlling the window through two or more inputs (e.g., multiple inputs or sequential inputs).

FIG. 9 illustrates an example of displaying a window in a tablet mode.

Referring to FIG. 9, in a situation 910, while a desktop mode (e.g., Dex mode) is activated, an electronic device 101 may display a task bar 911, a window 912 of Application B, and/or a window 916 of Application C via a display 203.

For example, the task bar 911 may include icons (or shortcuts) 911-1, 911-2, 911-3, 911-4, and 911-5 for executing predefined applications, a button 911-6 for displaying an execution history screen (or a recent view), a button 911-7 for displaying a home screen, and/or a button 911-8 for displaying a previous screen. However, the present disclosure is not limited thereto. For example, the task bar 911 may be implemented as a gesture bar for displaying the execution history screen through a swipe input.

For example, the window 912 of Application B may be displayed in the desktop mode. The window 912 in the desktop mode may include an execution screen 913 for displaying contents of Application B and a control bar 914. The control bar 914 may include a button 914-1 for minimizing a window size, a button 914-2 for maximizing the window size, and/or a button 914-3 for closing the window.

For example, the window 916 of Application C may be displayed in the desktop mode. The window 916 in the desktop mode may include an execution screen 917 for displaying contents of Application C and a control bar 918. The control bar 918 may include a button 918-1 for minimizing a window size, a button 918-2 for maximizing the window size, and/or a button 918-3 for closing the window.

For example, in the situation 910 of FIG. 9, the electronic device 101 may identify an input for the button 911-6.

In a situation 920, the electronic device 101 may display the execution history screen based on the input for the button 911-6. The execution history screen may comprise a first section 921 for displaying images 921-1 and 921-2 of applications executed in the desktop mode and at least a portion of images 931 and 932 of applications executed in the tablet mode. The first section 921 and a second section 922 may be visually separated. The number of images included within the first section 921 and/or the second section 922 is not limited to that illustrated in FIG. 9. In an example, an image of an application may be referred to as an application (“app”, in short) card or another term having an equivalent technical or functional meaning thereto. An area corresponding to the second section 922 displayed in FIG. 9 is merely an example, and the present disclosure is not limited thereto. For example, the area of the second section 922 may indicate an area excluding the first section 921.

For example, an image of an application displayed within the first section 921 and/or the second section 922 may be a snapshot, a captured image, or a thumbnail image of the application execution screen.

For example, the first section 921 for the desktop mode may be displayed via the display 203, but the second section 922 for the tablet mode may not be displayed via the display 203. That is, the second section 922 for the tablet mode may be invisible to a user. However, the present disclosure is not limited thereto.

For example, when the execution history screen is displayed in a state in which the desktop mode is activated, an area occupied by the first section 921 in an initial screen of the execution history screen may be larger than an area occupied by the second section 922. However, the present disclosure is not limited thereto. For example, the area occupied by the first section 921 in the initial screen may be smaller than or equal to the area occupied by the second section 922.

For example, the electronic device 101 may update the execution history screen based on an input for object navigation. In the example illustrated in FIG. 9, the electronic device 101 may identify a rightward swipe input. The rightward swipe input may be a swipe input from a contact start point 923 to a contact release point 924. Based on the rightward swipe input, the electronic device 101 may control the display 203 such that a displayed area of the execution history screen moves leftward. As the displayed area of the execution history screen moves leftward, a display ratio of the first section 921 may decrease, and a display ratio of the second section 922 may increase.

In a situation 930, the electronic device 101 may display the execution history screen updated according to movement of the displayed area of the execution history screen. The updated execution history screen may display the first section 921 and at least a portion of images of applications executed in the tablet mode (e.g., the image 931, the image 932, an image 933, an image 934, an image 935, an image 936, at least a portion of an image 937, and at least a portion of an image 938).

In the example illustrated in FIG. 9, the electronic device 101 may identify an input for the image 931 of Application A. Based on identifying the input for the image 931 of Application A, the electronic device 101 may deactivate the desktop mode and activate the tablet mode.

In a situation 940, the electronic device 101 may display a window 941 of Application A based on the input selecting the image 931 of Application A. For example, the window 941 of Application A may include only an execution screen 942 for displaying contents of Application A. However, this is merely an example, and the present disclosure is not limited thereto. For example, the window 941 in the tablet mode may further include a button for controlling the window through two or more inputs (e.g., multiple inputs or sequential inputs).

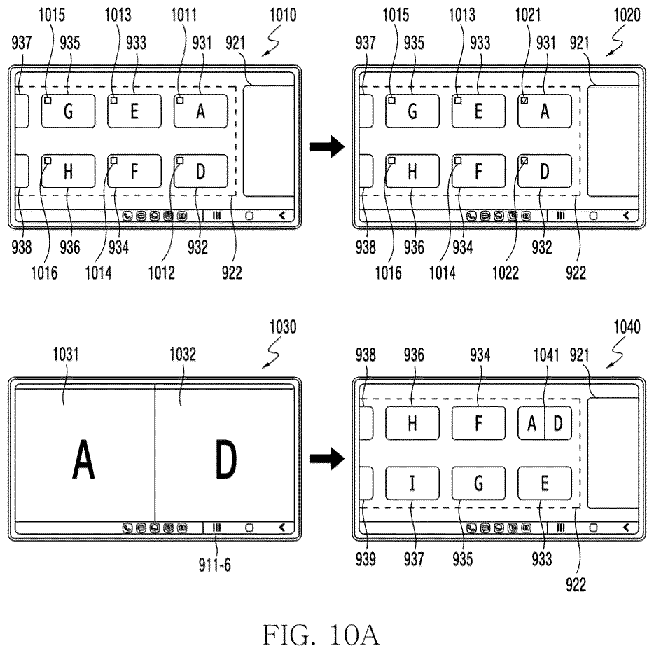

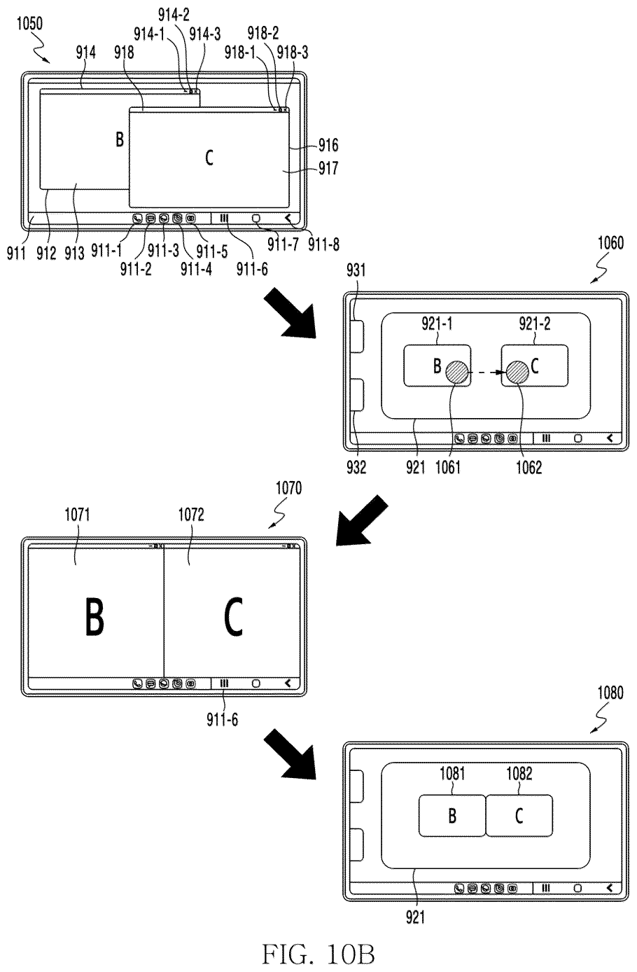

FIG. 10A illustrates an example of displaying split screen in a tablet mode.

Referring to FIG. 10A, in a situation 1010, an electronic device 101 may identify a long press input for a second section 922. Based on the long press input for the second section 922, the electronic device 101 may display a button, in images of the second section 922, for selecting an application to be displayed in split view. For example, the electronic device 101 may display a button 1011 for split view in an image 931 of Application A. For example, the electronic device 101 may display a button 1012 for split view in an image 932 of Application D. For example, the electronic device 101 may display a button 1013 for split view in an image 933 of Application E. For example, the electronic device 101 may display a button 1014 for split view in an image 934 of Application F. For example, the electronic device 101 may display a button 1015 for split view in an image 935 of Application G. For example, the electronic device 101 may display a button 1016 for split view in an image 936 of Application H. A button for split view may be displayed in an image 937 of Application I and an image 938 of Application J according to movement of a displayed area of an execution history screen.

In a situation 1020, the electronic device 101 may display selection indicators 1021 and 1022 for indicating that Application A and Application D are selected for split view, based on inputs for the button 1011 and the button 1012.

In a situation 1030, the electronic device 101 may display Application A and Application D in split view based on an input for a remaining area excluding a first section 921 and an area in which the images 931, 932, 933, 934, 935, 936, 937, 938 of the applications are displayed. Windows of Application A and Application D may be displayed based on the tablet mode. The windows in the tablet mode may include an execution screen 1031 of Application A and an execution screen 1032 of Application D. While displaying Application A and Application D in split view, the electronic device 101 may identify an input for a button 911-6 for displaying the execution history screen.

In a situation 1040, the electronic device 101 may display the execution history screen based on the input for the button 911-6. The execution history screen may include the first section 921 for displaying images of applications executed in the desktop mode and the second section 922 for displaying images 1041, 933, 934, 935, 936, 937, 938, and 939 of applications executed in the tablet mode. For example, an image of an application displayed within the second section 922 may be a snapshot, a captured image, or a thumbnail image of the application execution screen. For example, an image of an application displayed within the second section 922 may reflect a display state of the application. In an example, since Application A and Application B are displayed together in split view in the tablet mode, the image 1041 of the second section 922 may include both an image related to Application A and an image related to Application D.

FIG. 10B illustrates an example of displaying split screen in a tablet mode.

Referring to FIG. 10B, in a situation 1050, while a desktop mode (e.g., Dex mode) is activated, an electronic device 101 may display a task bar 911, a window 912 of Application B, and/or a window 916 of Application C via a display 203.

For example, the task bar 911 may include icons (or shortcuts) 911-1, 911-2, 911-3, 911-4, and 911-5 for executing predefined applications, a button 911-6 for displaying an execution history screen (or a recent view), a button 911-7 for displaying a home screen, and/or a button 911-8 for displaying a previous screen. However, the present disclosure is not limited thereto. For example, the task bar 911 may be implemented as a gesture bar for displaying the execution history screen through a swipe input.

For example, the window 912 of Application B may be displayed in the desktop mode. The window 912 in the desktop mode may include an execution screen 913 for displaying contents of Application B and a control bar 914. The control bar 914 may include a button 914-1 for minimizing a window size, a button 914-2 for maximizing the window size, and/or a button 914-3 for closing the window.

For example, the window 916 of Application C may be displayed in the desktop mode. The window 916 in the desktop mode may include an execution screen 917 for displaying contents of Application C and a control bar 918. The control bar 918 may include a button 918-1 for minimizing a window size, a button 918-2 for maximizing the window size, and/or a button 918-3 for closing the window.

For example, in the situation 1050 of FIG. 10B, the electronic device 101 may identify an input for the button 911-6.

In a situation 1060, the electronic device 101 may display the execution history screen based on the input for the button 911-6. The execution history screen may include a section 921 for displaying images 921-1 and 921-2 of applications executed in the desktop mode and at least a portion of images 931 and 932 of applications executed in the tablet mode. For example, an image of an application may be a snapshot, a captured image, or a thumbnail image of the application execution screen.

For example, in the situation 1060 of FIG. 10B, the electronic device 101 may identify a drag and drop input for the image 921-1 of Application B. For example, the drag and drop input may include selection of the image 921-1 through a contact point 1061 and release of the selection through a contact point 1062.

In a situation 1070, the electronic device 101 may display Application B and Application C in split view based on the drag and drop input for the image 921-1. The windows of Application B and Application C may be displayed based on the desktop mode. A window 1071 of Application B may include an execution screen for displaying the contents of Application B and a control bar. A window 1072 of Application C may include an execution screen for displaying the contents of Application C and a control bar. The control bar may include a button for minimizing a window size, a button for maximizing the window size, and/or a button for closing the window.

For example, in the situation 1070 of FIG. 10B, the electronic device 101 may identify an input for the button 911-6.

In a situation 1080, the electronic device 101 may display the execution history screen based on the input for the button 911-6. The execution history screen may comprise the first section 921 for displaying the images of the applications executed in the desktop mode. For example, an image of an application displayed within the first section 921 may reflect a display state of the application. In an example, since Application B and Application C are displayed together in split view in the desktop mode, the electronic device 101 may display an image 1081 of Application B and an image 1082 of Application C in a connected form.

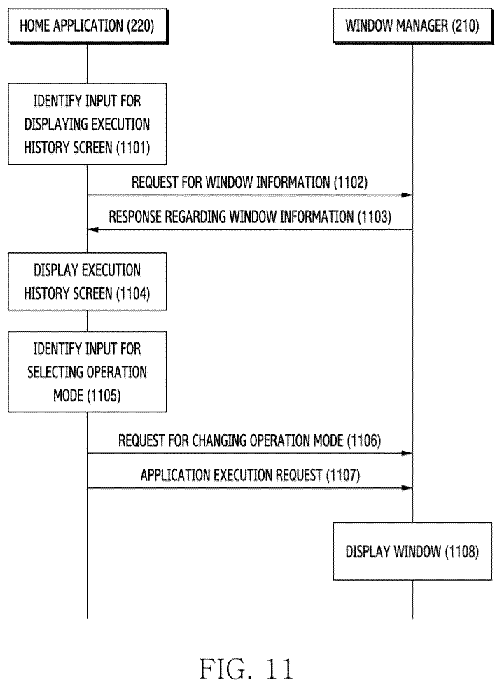

FIG. 11 illustrates signaling between a home application and a window manager for displaying a window. For example, an electronic device 101 may include a window manager 210 and a home application 220. The window manager 210 and/or the home application 220 may refer to a unit implemented in hardware or software to perform a designated function. For example, the window manager 210 may be a module for managing window information of each of applications. For example, the home application 220 may be an application for managing a default screen of the electronic device 101. In an example, the window manager 210 and/or the home application 220 may be implemented as a portion of the hardware components (e.g., the processor 201, the memory 202, and/or the display 203) exemplified in FIG. 2A. In an example, the window manager 210 and/or the home application 220 may also be implemented to be stored in the memory 202 of FIG. 2A in a form of instructions for performing the designated function.

Referring to FIG. 11, in operation 1101, the home application 220 according to an embodiment may identify an input for displaying an execution history screen. For example, the execution history screen may provide a list of applications executed by the electronic device 101 to a user. The applications included in the list may include applications currently being executed by the electronic device 101 and/or applications that were executed and then terminated by the electronic device 101. In an example, the execution history screen may be referred to as a recent view or another term having an equivalent technical or functional meaning thereto.

In operation 1102, the home application 220 according to an embodiment may provide a request for window information to the window manager 210 in response to or based on the input. For example, the window information may include a window mode (e.g., a desktop mode or a tablet mode), a window size, a window shape, a window creation time, and/or a stacking order (e.g., z-order) of each application. The window information may reflect the latest state of a window of an application. For example, the window manager 210 may obtain window information of the applications executed by the electronic device 101 from the memory 202 in response to or based on the request. In an example, the window manager 210 may obtain window information for applications executed in a desktop mode 240 from a first memory area of the memory 202, and may obtain window information for applications executed in a tablet mode 230 from a second memory area of the memory 202. That is, the first memory area related to the desktop mode may be different from the second memory area related to the tablet mode. However, the present disclosure is not limited to the above example. For example, the first memory area related to the desktop mode may be substantially the same as the second memory area related to the tablet mode.

In operation 1103, the home application 220 according to an embodiment may obtain a response including the window information from the window manager 210.

In operation 1104, the home application 220 according to an embodiment may control the display 203 to display the execution history screen based on the window information. For example, the execution history screen may comprise a first section for the desktop mode and a second section for the tablet mode.

In operation 1105, the home application 220 according to an embodiment may identify an input for selecting an operation mode in the execution history screen. For example, the input for selecting the operation mode may be an input related to the first section or an input related to the second section.

In operation 1106, the home application 220 according to an embodiment may provide a request for changing the operation mode to the window manager 210. For example, when the input related to the first section is identified, the electronic device 101 may provide a request for activating the desktop mode to the window manager 210. For example, when the input related to the second section is identified, the electronic device 101 may provide a request for activating the tablet mode to the window manager 210.

In operation 1107, the home application 220 according to an embodiment may provide an application execution request to the window manager 210. For example, when the input related to the first section is identified, the electronic device 101 may provide an execution request for applications of the first section to the window manager 210. For example, when the input related to the second section is identified, the electronic device 101 may provide an execution request for an application selected in the second section to the window manager 210.

In operation 1108, the window manager 210 according to an embodiment may display a window of an application. For example, in response to or based on receiving the request for activating the desktop mode and the execution request for the applications of the first section, the electronic device 101 may display windows for the applications of the first section in the desktop mode. For example, in response to or based on receiving the request for activating the tablet mode and the execution request for the application selected in the second section, the electronic device 101 may display a window for the selected application in the tablet mode.

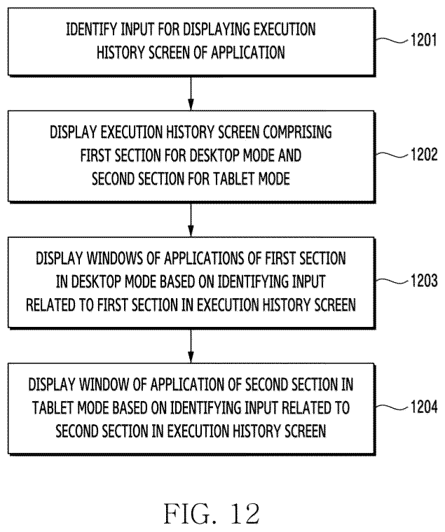

FIG. 12 is a flowchart indicating operations of an electronic device for displaying a window in a desktop mode or a tablet mode. The operations of FIG. 12 may be performed by the electronic device 101 of FIGS. 1, 2A, and 2B. For example, at least a portion of the operations may be controlled by a processor 201 of the electronic device 101. Hereinafter, each of the operations may be performed sequentially, but is not necessarily performed in sequence. For example, an order of each of the operations may be changed and/or at least two operations may be performed in parallel.

Referring to FIG. 12, in operation 1201, the electronic device 101 according to an embodiment may identify an input for displaying an execution history screen of an application. For example, the execution history screen may provide a list of applications executed by the electronic device 101 to a user. The applications included in the list may include applications currently being executed by the electronic device 101 and/or applications that were executed and then terminated by the electronic device 101. In an example, the execution history screen may be referred to as a recent view or another term having an equivalent technical or functional meaning thereto.

In an embodiment, the electronic device 101 may display an object for identifying an input for displaying the execution history screen on at least a portion of a current screen. In an example, the object may be an object for identifying a touch input. In a case of an object for identifying the touch input, it may be implemented in a button form (e.g., the button 511-6 of FIG. 5A and/or the button 911-6 of FIG. 9). For another example, the object may be an object for identifying a swipe input. The object for identifying the swipe input may be implemented in a bar form (e.g., a gesture bar). The object for identifying the input for displaying the execution history screen may be configured as the button and/or the bar according to user settings.

In an embodiment, the electronic device 101 may obtain window information from memory 202 based on identifying the input. For example, the window information may include a window mode (e.g., the desktop mode or the tablet mode), a window size, a window shape, a window creation time, and/or a stacking order (e.g., z-order) of each application. The window information may reflect the latest state of a window of an application. In an example, the electronic device 101 may obtain window information for applications executed in the desktop mode from a first memory area of the memory 202, and may obtain window information for applications executed in the tablet mode from a second memory area of the memory 202. That is, the first memory area related to the desktop mode may be different from the second memory area related to the tablet mode. However, the present disclosure is not limited thereto. For example, the first memory area related to the desktop mode may be substantially the same as the second memory area related to the tablet mode.

In operation 1202, the electronic device 101 according to an embodiment may display the execution history screen comprising a first section for the desktop mode and a second section for the tablet mode. In an example, a section may be referred to as a field, a workspace, or another term having an equivalent technical or functional meaning thereto.

In an embodiment, the electronic device 101 may display the execution history screen including the first section for displaying images of the applications executed in the desktop mode and the second section for displaying images of the applications executed in the tablet mode based on the window information obtained from the memory 202. In an example, an image of an application displaying within the first section and/or the second section may be a snapshot, a captured image, or a thumbnail image of the application execution screen.

In an embodiment, the first section for the desktop mode may be displayed via a display 203, but the second section for the tablet mode may not be displayed via the display 203. That is, the second section for the tablet mode may be a logically defined area, and may be invisible to the user. However, the present disclosure is not limited to the above example. For example, the first section for the desktop mode and the second section for the tablet mode may be respectively displayed or not displayed via the display 203. For example, the first section and the second section may be individually controlled by one home application 220.

In an embodiment, the first section and the second section may be logically separated in the execution history screen. For example, since the first memory area storing the window information of the applications related to the first section and the second memory area storing the window information of the applications related to the second section are different, the first section and the second section may be logically separated. In an example, since the first section and the second section are logically separated, the electronic device 101 may ignore a drag and drop input from the first section to the second section. In an example, the electronic device 101 may ignore a ‘drag-and-drop’ input from the second section to the first section. However, the present disclosure is not limited to the above example. The electronic device 101 may change a mode of an application from the desktop mode to the tablet mode based on a drag and drop input from the first section to the second section. The electronic device 101 may change a mode of an application from the tablet mode to the desktop mode based on a drag and drop input from the second section to the first section.

In an embodiment, when the execution history screen is displayed in a state in which the desktop mode is activated, an area occupied by the first section in an initial screen of the execution history screen may be larger than an area occupied by the second section. For another example, in a state in which the tablet mode is activated, the area occupied by the first section in the initial screen may be smaller than the area occupied by the second section. However, the present disclosure is not limited to the examples described above.

In an embodiment, the electronic device 101 may update the execution history screen based on an input for object navigation. For example, the execution history screen may comprise the first section on a right side and the second section on a left side.

For example, the input for object navigation may be a leftward swipe input. The leftward swipe input may correspond to a gesture of moving a finger in contact with the display 203 from right to left. Based on the leftward swipe input, the electronic device 101 may control the display 203 such that a displayed area of the execution history screen moves rightward. As the displayed area of the execution history screen moves rightward, a display ratio of the first section may increase, and a display ratio of the second section may decrease. The display ratio of the first section may indicate a ratio of the area occupied by the first section in the execution history screen. The display ratio of the second section may indicate a ratio of the area occupied by the second section in the execution history screen.

For example, the input for object navigation may be a rightward swipe input. The rightward swipe input may correspond to a gesture of moving a finger in contact with the display 203 from left to right. Based on the rightward swipe input, the electronic device 101 may control the display 203 such that the displayed area of the execution history screen moves leftward. As the displayed area of the execution history screen moves leftward, the display ratio of the first section may decrease, and the display ratio of the second section may increase.

In operation 1203, the electronic device 101 according to an embodiment may display windows of the applications of the first section in the desktop mode based on identifying an input related to the first section in the execution history screen.

In an embodiment, the electronic device 101 may identify an input related to the first section. For example, based on the input related to the first section, the electronic device 101 may deactivate the tablet mode and activate the desktop mode. A window of an application executed after the desktop mode is activated may be displayed in the desktop mode. In an example, the input related to the first section may be an input selecting an image of an application displayed within the first section. For another example, the input related to the first section may be an input for a remaining area within the first section excluding an area in which the images of the applications are displayed.

In an embodiment, the electronic device 101 may determine a stacking order of the applications to display the windows for the applications of the first section in the desktop mode. For example, the stacking order may indicate an order in which the windows of the applications are displayed. In an example, when a stacking order of a first application is higher than a stacking order of a second application, a window of the first application may be overlaid on a window of the second application. In this case, the window of the first application may be displayed with priority over the window of the second application. For example, in an area in which the window of the first application and the window of the second application overlap, the window of the first application may be displayed, and the window of the second application may not be displayed.

For example, the electronic device 101 may determine the stacking order based on an input related to the first section and/or the window information. For example, when an input selecting an image of an application displayed within the first section is identified, the electronic device 101 may change (or update) the stacking order based on the window information such that the corresponding application has the highest stacking order. An example of such a case may be referenced in the description of FIG. 5A above. For example, when an input for the remaining area within the first section excluding the area in which the images of the applications are displayed is identified, the electronic device 101 may determine the stacking order based on the window information. An example of such a case may be referenced in the description of FIG. 6 above.

In an embodiment, the electronic device 101 may display the windows for the applications of the first section in the desktop mode based on the determined stacking order. The windows in the desktop mode may include an execution screen of each application and window control buttons.

In operation 1204, the electronic device 101 according to an embodiment may display a window of an application of the second section in the tablet mode based on identifying an input related to the second section in the execution history screen.

In an embodiment, the electronic device 101 may identify an input related to the second section. For example, based on the input related to the second section, the electronic device 101 may deactivate the desktop mode and activate the tablet mode. A window of an application executed after the tablet mode is activated may be displayed in the tablet mode. For example, the input related to the second section may be an input selecting one image among the images of the applications displayed within the second section.

In an embodiment, the electronic device 101 may display a window of the selected application in the tablet mode. For example, the window in the tablet mode may include only an execution screen for displaying contents of the application. However, the present disclosure is not limited to the above example. For example, the window in the tablet mode may further include a button for controlling the window through two or more inputs (e.g., multiple inputs or sequential inputs).

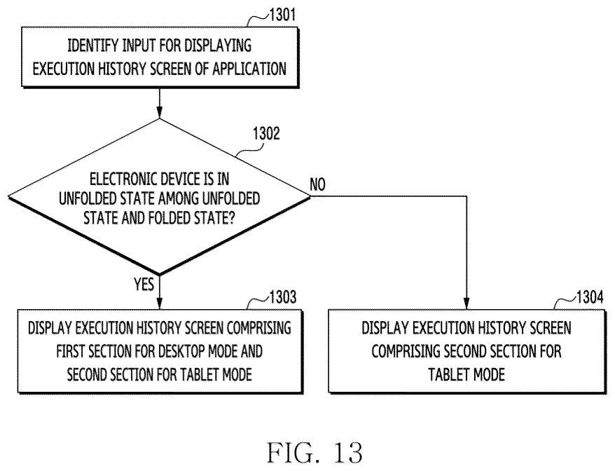

FIG. 13 illustrates a flowchart indicating operations of a foldable electronic device for displaying an execution history screen. The operations of FIG. 13 may be performed by the electronic device 101 of FIGS. 1, 2A, and 2B. For example, at least a portion of the operations may be controlled by a processor 201 of the electronic device 101. Hereinafter, each of the operations may be performed sequentially, but is not necessarily performed in sequence. For example, an order of each of the operations may be changed and/or at least two operations may be performed in parallel. The electronic device 101 described in FIG. 13 may be a foldable electronic device or a multi-foldable electronic device.

Referring to FIG. 13, in operation 1301, the electronic device 101 according to an embodiment may identify an input for displaying an execution history screen of an application. For example, the execution history screen may provide a list of applications executed by the electronic device 101 to a user. The applications included in the list may include applications currently being executed by the electronic device 101 and/or applications that were executed and then terminated by the electronic device 101. In an example, the execution history screen may be referred to as a recent view or another term having an equivalent technical or functional meaning thereto.

In operation 1302, the electronic device 101 according to an embodiment may determine whether the electronic device 101 is in an unfolded state among an unfolded state and a folded state. For example, in the unfolded state of the electronic device 101, contents may be displayed on a main display of a display 203. For example, in the folded state of the electronic device 101, contents may be displayed on a cover display of the display 203. A display region of the main display may be larger than a display region of the cover display.

In operation 1303, the electronic device 101 according to an embodiment may display the execution history screen comprising a first section for a desktop mode and a second section for a tablet mode according to a determination that the electronic device 101 is in the unfolded state.

In an embodiment, the electronic device 101 may display the execution history screen comprising the first section for displaying images of applications executed in the desktop mode and the second section for displaying images of applications executed in the tablet mode based on window information obtained from memory 202. For example, since the display region of the main display of the display 203 in the unfolded state is relatively large, the execution history screen may comprise both the first section and the second section.

In operation 1304, the electronic device 101 according to an embodiment may display the execution history screen comprising the second section for the tablet mode according to a determination that the electronic device 101 is in the folded state. For example, since the display region of the cover display of the display 203 in the folded state is relatively narrow, the execution history screen may comprise only the second section among the first section for the desktop mode and the second section for the tablet mode. However, this is merely an example, and the present disclosure is not limited to the above example. For example, the execution history screen may include only the first section among the first section and the second section.

The technical problems to be achieved in the present disclosure are not limited to those described above, and other technical problems not mentioned herein will be clearly understood by those having ordinary knowledge in the art to which the present disclosure belongs.

As described above, an electronic device 101 may include a display 203. The electronic device 101 may include memory 202, comprising one or more storage media, storing instructions. The electronic device 101 may include at least one processor 201 including processing circuitry. The instructions, when executed by the at least one processor 201 individually or collectively, may cause the electronic device 101 to identify an input for displaying an execution history screen of applications. The instructions, when executed by the at least one processor 201 individually or collectively, may cause the electronic device 101 to, based on the input, display, via the display, the execution history screen comprising a first image for an execution screen of a first application executed in a desktop mode having a first user interface (UI) configuration displaying both window control buttons and an application execution screen, and a second image for an execution screen of a second application executed in a tablet mode having a second UI configuration displaying the application execution screen. The instructions, when executed by the at least one processor 201 individually or collectively, may cause the electronic device 101 to, based on identifying an input related to the first image in the execution history screen, display, via the display, a window including both the execution screen of the first application and the window control buttons, in the desktop mode. The instructions, when executed by the at least one processor 201 individually or collectively, may cause the electronic device 101 to, based on identifying an input related to the second image in the execution history screen, display, via the display, a window including the execution screen of the second application, in the tablet mode.

For example, the window control buttons may include a button for minimizing a window size, a button for maximizing the window size, and a button for closing the window. The window in the tablet mode may not include the window control buttons.

For example, the instructions, when executed by the at least one processor individually or collectively, may cause the electronic device to, based on the input for displaying the execution history screen, obtain first window information of applications executed in the desktop mode and second window information of applications executed in the tablet mode. The first window information may be obtained from a first memory area of the memory. The second window information may be obtained from a second memory area different from the first memory area of the memory.

For example, the execution history screen may include a first section for the desktop mode and a second section for the tablet mode. The first section may include at least a portion of the first image for the execution screen of the first application. The second section may include at least a portion of the second image for the execution screen of the second application. The first section and the second section may be visually separated from each other.

For example, when the input for displaying the execution history screen is identified while the desktop mode is activated, an area occupied by a first section for the desktop mode in the execution history screen may be larger than an area occupied by a second section for the tablet mode. When the input for displaying the execution history screen is identified while the tablet mode is activated, an area occupied by the first section for the desktop mode in the execution history screen may be smaller than an area occupied by the second section for the tablet mode.

For example, a first section for the desktop mode may further include a third image for an execution screen of a third application. The instructions, when executed by the at least one processor individually or collectively, may cause the electronic device to, based on an input selecting the first image in the execution history screen, display a window of the first application and a window of the third application such that the window of the first application has a higher stacking order than the window of the third application. The instructions, when executed by the at least one processor individually or collectively, may cause the electronic device to, based on an input selecting the third image in the execution history screen, display the window of the first application and the window of the third application such that the window of the third application has a higher stacking order than the window of the first application.

For example, the instructions, when executed by the at least one processor individually or collectively, may cause the electronic device to, based on an input for a remaining area of the first section excluding an area occupied by the first image and the third image, determine a stacking order for the first application and the third application from window information. The instructions, when executed by the at least one processor individually or collectively, may cause the electronic device to, based on the determined stacking order, display the window of the first application and the window of the third application.

For example, the instructions, when executed by the at least one processor individually or collectively, may cause the electronic device to, based on a long press input on a first section for the desktop mode in the execution history screen, display a user interface (UI) element in the first image for removing the first image of the first application from the first section. The instructions, when executed by the at least one processor individually or collectively, may cause the electronic device to, based on an input for the UI element, remove the first image from the first section.

For example, the instructions, when executed by the at least one processor individually or collectively, may cause the electronic device to, based on identifying an input related to the first image in the execution history screen while the tablet mode is activated, activate the desktop mode. The electronic device, when executed by the at least one processor individually or collectively, may cause the electronic device to, based on identifying an input for executing an application after activating the desktop mode, display a window including both an execution screen of the application and the window control buttons.

For example, the instructions, when executed by the at least one processor individually or collectively, may cause the electronic device to, based on identifying an input related to the second image in the execution history screen while the desktop mode is activated, activate the tablet mode. The instructions, when executed by the at least one processor individually or collectively, may cause the electronic device to, based on identifying an input for executing an application after activating the tablet mode, display a window including only an execution screen of the application.

As described above, a method performed by an electronic device including a display may include identifying an input for displaying an execution history screen of applications. The method may include, based on the input, displaying, via the display, the execution history screen comprising a first image for an execution screen of a first application executed in a desktop mode having a first user interface (UI) configuration displaying both window control buttons and an application execution screen, and a second image for an execution screen of a second application executed in a tablet mode having a second UI configuration displaying the application execution screen. The method may include, based on identifying an input related to the first image in the execution history screen, displaying, via the display, a window including both the execution screen of the first application and the window control buttons, in the desktop mode. The method may include, based on identifying an input related to the second image in the execution history screen, displaying, via the display, a window including the execution screen of the second application, in the tablet mode.

For example, the window control buttons may include a button for minimizing a window size, a button for maximizing the window size, and a button for closing the window. The window in the tablet mode may not include the window control buttons.

For example, the method may include, based on the input for displaying the execution history screen, obtaining first window information of applications executed in the desktop mode and second window information of applications executed in the tablet mode. The first window information may be obtained from a first memory area of memory of the electronic device. The second window information may be obtained from a second memory area different from the first memory area of the memory.

For example, the execution history screen may include a first section for the desktop mode and a second section for the tablet mode. The first section may include at least a portion of the first image for the execution screen of the first application. The second section may include at least a portion of the second image for the execution screen of the second application. The first section and the second section may be visually separated from each other.

For example, when the input for displaying the execution history screen is identified while the desktop mode is activated, an area occupied by a first section for the desktop mode in the execution history screen may be larger than an area occupied by a second section for the tablet mode. When the input for displaying the execution history screen is identified while the tablet mode is activated, an area occupied by the first section for the desktop mode in the execution history screen may be smaller than an area occupied by the second section for the tablet mode.

For example, a first section for the desktop mode may further include a third image for an execution screen of a third application. The method may include, based on an input selecting the first image in the execution history screen, displaying a window of the first application and a window of the third application such that the window of the first application has a higher stacking order than the window of the third application. The method may include, based on an input selecting the third image in the execution history screen, displaying the window of the first application and the window of the third application such that the window of the third application has a higher stacking order than the window of the first application.

For example, the method may include, based on an input for a remaining area of the first section excluding an area occupied by the first image and the third image, determining a stacking order for the first application and the third application from window information. The method may include, based on the determined stacking order, displaying the window of the first application and the window of the third application.

For example, the method may include, based on a long press input on a first section for the desktop mode in the execution history screen, displaying a user interface (UI) element in the first image for removing the first image of the first application from the first section. The method may include, based on an input for the UI element, removing the first image from the first section.

For example, the method may include, based on identifying an input related to the first image in the execution history screen while the tablet mode is activated, activating the desktop mode. The method may include, based on identifying an input for executing an application after activating the desktop mode, displaying a window including both an execution screen of the application and the window control buttons.

For example, the method may include, based on identifying an input related to the second image in the execution history screen while the desktop mode is activated, activating the tablet mode. The method may include, based on identifying an input for executing an application after activating the tablet mode, displaying a window including only an execution screen of the application.

The effects obtainable from the present disclosure are not limited to those mentioned above, and other effects not mentioned herein may be clearly understood by those of ordinary skill in the art to which the present disclosure belongs.

For one or more embodiments, at least one of the components described in one or more of the preceding figures may be configured to perform one or more operations, techniques, processes, and/or methods as described in the present disclosure. For example, the processor (e.g., a baseband processor) described in the present disclosure in connection with one or more of the preceding figures may be configured to operate according to one or more examples described in the present disclosure. For another example, circuitry associated with a user equipment (UE), a base station, a network element, and the like, as described above in connection with one or more of the preceding figures, may be configured to operate according to one or more examples described herein.

Any of the embodiments described above may be combined with any other embodiment (or combination of embodiments) unless explicitly stated otherwise. The foregoing description of one or more implementations provides examples and explanations, but is not intended to limit or strictly confine the scope of the embodiments to the exact forms disclosed. In light of the above teachings, modifications and variations may be possible, or may be derived from the practice of various embodiments.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

Various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., through at least one wire), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function based on the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display;
memory, comprising one or more storage media, storing instructions; and
at least one processor including processing circuitry, wherein the instructions, when executed by the at least one processor individually or collectively, cause the electronic device to:
identify an input for displaying an execution history screen of applications;
based on the input, display, via the display, the execution history screen comprising:
a first image for an execution screen of a first application executed in a desktop mode having a first user interface (UI) configuration displaying both window control buttons and an application execution screen, and
a second image for an execution screen of a second application executed in a tablet mode having a second UI configuration displaying the application execution screen;
based on identifying an input related to the first image in the execution history screen, display, via the display, a first window including both the execution screen of the first application and the window control buttons, in the desktop mode; and
based on identifying an input related to the second image in the execution history screen, display, via the display, a second window including the execution screen of the second application, in the tablet mode.

2. The electronic device of claim 1, wherein the window control buttons include a button for minimizing a window size, a button for maximizing the window size, and a button for closing the window, and
wherein the second window omits the window control buttons.

3. The electronic device of claim 1, wherein the instructions, when executed by the at least one processor individually or collectively, cause the electronic device to, based on the input for displaying the execution history screen, obtain first window information of applications executed in the desktop mode and second window information of applications executed in the tablet mode,
wherein the first window information is obtained from a first memory area of the memory, and
wherein the second window information is obtained from a second memory area different from the first memory area of the memory.

4. The electronic device of claim 1, wherein the execution history screen comprises a first section for the desktop mode and a second section for the tablet mode,
wherein the first section includes at least a portion of the first image for the execution screen of the first application,
wherein the second section includes at least a portion of the second image for the execution screen of the second application, and
wherein the first section and the second section are visually separated.

5. The electronic device of claim 1, wherein, when the input for displaying the execution history screen is identified in the desktop mode, an area occupied by a first section for the desktop mode in the execution history screen is larger than an area occupied by a second section for the tablet mode, and
wherein, when the input for displaying the execution history screen is identified in the tablet mode, an area occupied by the first section for the desktop mode in the execution history screen is smaller than an area occupied by the second section for the tablet mode.

6. The electronic device of claim 1, wherein a first section for the desktop mode further includes a third image for an execution screen of a third application,
wherein the instructions, executed by the at least one processor individually or collectively, cause the electronic device to:
based on an input selecting the first image in the execution history screen, display a window of the first application and a window of the third application such that the window of the first application has a higher stacking order than the window of the third application; and
based on an input selecting the third image in the execution history screen, display the window of the first application and the window of the third application such that the window of the third application has a higher stacking order than the window of the first application.

7. The electronic device of claim 6, wherein the instructions, when executed by the at least one processor individually or collectively, cause the electronic device to:
based on an input for a remaining area of the first section excluding an area occupied by the first image and the third image, determine a stacking order for the first application and the third application from window information; and
based on the determined stacking order, display the window of the first application and the window of the third application.

8. The electronic device of claim 1, wherein the instructions, when executed by the at least one processor individually or collectively, cause the electronic device to:
based on a long press input on a first section for the desktop mode in the execution history screen, display a user interface (UI) element in the first image for removing the first image of the first application from the first section; and
based on an input for the UI element, remove the first image from the first section.

9. The electronic device of claim 1, wherein the instructions, when executed by the at least one processor individually or collectively, cause the electronic device to:
based on identifying an input related to the first image in the execution history screen in the tablet mode, activate the desktop mode; and
based on identifying an input for executing an application after activating the desktop mode, display a window including both an execution screen of the application and the window control buttons.

10. The electronic device of claim 1, wherein the instructions, when executed by the at least one processor individually or collectively, cause the electronic device to:
based on identifying an input related to the second image in the execution history screen in the desktop mode, activate the tablet mode; and
based on identifying an input for executing an application after activating the tablet mode, display a window including only an execution screen of the application.

11. A method performed by an electronic device including a display, comprising:
identifying an input for displaying an execution history screen of applications;
based on the input, displaying, via the display, the execution history screen comprising:
a first image for an execution screen of a first application executed in a desktop mode having a first user interface (UI) configuration displaying both window control buttons and an application execution screen, and
a second image for an execution screen of a second application executed in a tablet mode having a second UI configuration displaying the application execution screen;
based on identifying an input related to the first image in the execution history screen, displaying, via the display, a first window including both the execution screen of the first application and the window control buttons, in the desktop mode; and
based on identifying an input related to the second image in the execution history screen, displaying, via the display, a second window including the execution screen of the second application, in the tablet mode.

12. The method of claim 11, wherein the window control buttons include a button for minimizing a window size, a button for maximizing the window size, and a button for closing the window, and
wherein the second window omits the window control buttons.

13. The method of claim 11, further comprising:
based on the input for displaying the execution history screen, obtaining first window information of applications executed in the desktop mode and second window information of applications executed in the tablet mode,
wherein the first window information is obtained from a first memory area of memory of the electronic device, and
wherein the second window information is obtained from a second memory area different from the first memory area of the memory.

14. The method of claim 11, wherein the execution history screen comprises a first section for the desktop mode and a second section for the tablet mode,
wherein the first section includes at least a portion of the first image for the execution screen of the first application,
wherein the second section includes at least a portion of the second image for the execution screen of the second application, and
wherein the first section and the second section are visually separated.

15. The method of claim 11, wherein, when the input for displaying the execution history screen is identified in the desktop mode, an area occupied by a first section for the desktop mode in the execution history screen is larger than an area occupied by a second section for the tablet mode, and
wherein, when the input for displaying the execution history screen is identified in the tablet mode, an area occupied by the first section for the desktop mode in the execution history screen is smaller than an area occupied by the second section for the tablet mode.

16. The method of claim 11, wherein a first section for the desktop mode further includes a third image for an execution screen of a third application, and
wherein the method further comprises:
based on an input selecting the first image in the execution history screen, displaying a window of the first application and a window of the third application such that the window of the first application has a higher stacking order than the window of the third application; and
based on an input selecting the third image in the execution history screen, displaying the window of the first application and the window of the third application such that the window of the third application has a higher stacking order than the window of the first application.

17. The method of claim 16, further comprising:
based on an input for a remaining area of the first section excluding an area occupied by the first image and the third image, determining a stacking order for the first application and the third application from window information; and
based on the determined stacking order, displaying the window of the first application and the window of the third application.

18. The method of claim 11, further comprising:
based on a long press input on a first section for the desktop mode in the execution history screen, displaying a user interface (UI) element in the first image for removing the first image of the first application from the first section; and
based on an input for the UI element, removing the first image from the first section.

19. The method of claim 11, further comprising:
based on identifying an input related to the first image in the execution history screen in the tablet mode, activating the desktop mode; and
based on identifying an input for executing an application after activating the desktop mode, displaying a window including both an execution screen of the application and the window control buttons.

20. The method of claim 11, further comprising:
based on identifying an input related to the second image in the execution history screen in the desktop mode, activating the tablet mode; and
based on identifying an input for executing an application after activating the tablet mode, displaying a window including only an execution screen of the application.
